(19) United States
(12) Patent Application Publication
(10) Pub. No.: US 2016/0227521 A1
(43) Pub. Date: Aug. 4, 2016

(54) Method and system for transmitting physical downlink shared channel, and network side device

(71) Applicant: ZTE CORPORATION, Shenzhen, GD (CN)

(72) Inventors: Xiaogang Han, Shenzhen (CN); Bo Dai, Shenzhen (CN); Focai Peng, Shenzhen (CN)

(21) Appl. No.: 14/908,966

(22) PCT Filed: Jul. 1, 2014
(86) PCT No.: PCT/CN2014/081405

§ 371 Date: Mar. 24, 2016

(30) Foreign Application Priority Data
Aug. 8, 2013 (CN) 201310344667.9

(51) Int. Cl. H04W 72/04; H04L 5/00

(52) U.S. Cl. CPC H04W 72/042; H04L 5/0048; H04W 72/0453

(57) ABSTRACT

A method and system for PDSCH transmission and a network side device are provided. The method includes: a network side device determines a transmission parameter of a PDSCH according to information related to scheduled UE, the transmission parameter of the PDSCH including at least one of: a transmission manner of the PDSCH and a power ratio of a reference signal corresponding to the PDSCH to data corresponding to the reference signal (101), and the information related to the scheduled UE including at least one of: CSI reported by the UE, a TM of the UE, version and support capability information of the UE, type information of a serving cell where the PDSCH is located and type information of a subframe where the PDSCH is located; and the network side device performs resource mapping and sending according to the determined transmission parameter of the PDSCH (102).

### TECHNICAL FIELD

The disclosure relates to the field of wireless communication, and in particular to a method and system for Physical Downlink Shared Channel (PDSCH) transmission and a network side device.

### BACKGROUND

A Long-Term Evolution (LTE) standard defines a Physical Downlink Control Channel (PDCCH) configured to bear Downlink Control Information (DCI), including uplink and downlink scheduling information and uplink power control information. DCI formats in LTE Release 11 (R11) include: DCI Format 0, DCI Format 1, DCI Format 1A, DCI Format 1B, DCI Format 1C, DCI Format 1D, DCI Format, DCI Format 2A, DCI Format 2B, DCI Format 2C, DCI Format 2C, DCI Format 3, DCI Format 3A, DCI Format 4 and the like. Along with development of a Coordinated Multiple Points (CoMP) technology, LTE R11 also proposes enhancement of a PDCCH, i.e. an Enhanced PDCCH (ePDCCH), both a time-domain starting location and frequency-domain location of the ePDCCH being quite different from those of the PDCCH.

LTE also defines a Transmission Mode (TM) selected for transmission of a Physical Downlink Shared Channel (PDSCH) of each piece of User Equipment (UE), and at present, R11 defines 10 TMs, i.e. TM1-TM10, wherein DCI Format 1A, serving as a fallback of each TM, is mainly adopted in case of unreliable channel measurement and TM reconfiguration.

Along with development of a carrier aggregation technology in LTE-Advanced (LTE-A), LTE R11 proposes a new-type carrier, such a new-type carrier being a non-backward compatible carrier, and gives two possible forms of the carrier: a carrier segment and an extension carrier.

Here, the carrier segment is a non-compatible carrier (not compatible with an old version), and the carrier segment cannot be used independently, and only serves as part of a bandwidth of a certain backward compatible carrier to improve a transmission capability of a data field of the backward compatible carrier; the bandwidth sum of the carrier segment and the backward compatible carrier paired with the carrier segment does not exceed 110 Resource Blocks (RBs); and

the extension carrier is a non-backward compatible carrier which does not operate independently, is required to be paired with a certain backward compatible carrier for use as part of the backward compatible carrier, and operates in a carrier aggregation manner; and a size of the extension carrier is required to be one of six bandwidths (1.4, 3, 5, 10, 15 and 20 MHz) supported by an existing LTE system.

Main characteristics of the two new-type carriers are shown in Table 1:

TABLE 1

| Extension carrier | Carrier segment |
|---|---|
| 1: there is no Physical Broadcast Channel | 1: there is no PBCH/SIB/paging; |
| (PBCH)/System Information Block | 2: there is no PSS/SSS; |
| (SIB)/paging; | 3: no PDCCH/PHICH/PCFICH is |
| 2: there is no Primary Synchronization | transmitted; |
| Signal (PSS)/Secondary Synchronization | 4: there is no CRS; |
| Signal (SSS); | 5: the carrier segment is required to be |
| 3: no PDCCH/Physical Hybrid Automatic | combined with a backward compatible |
| Repeat Request Indication Channel | carrier for operation; |
| (PHICH)/Physical Control Format | 6: the carrier segment is measured on the |
| Indication Channel (PCFICH) is | backward compatible carrier; |
| transmitted; | 7: an HARQ process is shared with the |
| 4: there is no Cell-specific Reference | associated compatible carrier; |
| Signal (CRS); | 8: a resource of the carrier segment may |
| 5: the extension carrier is required to be | be considered as part of a Physical Uplink |
| combined with a backward compatible | Shared Channel (PUSCH) of the |
| carrier for operation; | associated compatible carrier, and may be |
| 6: the extension carrier is measured on the | scheduled by a PDCCH in the compatible |
| backward compatible carrier; | carrier in a unified manner; |
| 7: the size is required to be one of six | 9: the carrier segment and its paired |
| bandwidths (1.4, 3, 5, 10, 15 and 20 MHz) | compatible carrier are continuous in |
| supported by an existing LTE system; | frequency, and the bandwidth sum of the |
| 8: a resource of the extension carrier is | two does not exceed 110 RBs; |
| scheduled by an independent PDCCH | 10: the carrier segment and its associated |
| located in the compatible carrier; | compatible carrier use the same TM; |
| 9: it is needed to adopt an independent | 11: residence of UE is forbidden; and |
| Hybrid Automatic Repeat Request (HARQ) | 12: mobility measurement is not supported. |
| process; | |
| 10: the extension carrier and the | |
| compatible carrier paired with the | |
| extension carrier may use different TMs; | |
| 11: residence of UE is forbidden; and | |
| 12: mobility measurement is not supported. | |

At present, a 5 ms-periodic LTE R8/R9/R10 single-port CRS in a new carrier is adopted for synchronization tracking, and such a reference signal may be called a Reduced CRS (RCRS); and a downlink TM of the new carrier performs demodulation on the basis of a Demodulation Reference Signal (DMRS) and performs channel measurement on the basis of a Channel State Information-Reference Signal (CSI-RS) to confirm that DCI Format 1A and DCI Format 2C may be adopted for scheduling of a PDSCH, and it is specified that a supported TM TM10 and a newly introduced DCI Format 2D in CoMP are required to be supported in the new carrier, which makes it apparent that the new carrier is also required to support enhancement of a downlink DMRS.

At present, data demodulation of a New Carrier Type (NCT) is only based on a DMRS, and it is specified that DCI Formats 1A and 2C and newly introduced TM10 are adopted to support transmission of a PDSCH in a new carrier. When the downlink bandwidths are the same, a bit load required by DCI Format 1A is much lower than that required by DCI Format 2C/2D, and a Distributed Virtual Resource Block (DVRB)-based resource distribution manner is not supported by current DMRS antenna port-based transmission, so that a bit field used to indicate distribution of a Localized/Distributed Virtual Resource Block (localized/distributed VRB) in DCI Format 1A of the NCT may be optimized; and when a Node B is required to retransmit downlink data of UE, 3 bits reserved in a Modulation and Coding Scheme (MCS) indication field in DCI Format 1A may be used for other purposes because DCI Format 1A for scheduling a retransmission resource is not required to indicate a size of a Transport Block (TB) during retransmission.

At present, there is no final conclusion about a discussion about a TM of a new carrier, and although it is specified that DCI Format 1A adopts a single-DMRS antenna port-based transmission manner when scheduling a PDSCH of UE, there is yet no conclusion about whether such a manner provides reliable fallback or not at present; when a fallback manner having higher reliability is introduced, for example, DMRS-based transmission diversity or antenna diversity based on different DMRS ports between Resource Elements (REs) in an RB, if these highly reliable fallback operations are all introduced, it is needed to indicate the manner adopted for transmission in a PDSCH transmission process; and moreover, in the PDSCH transmission process, in order to improve channel estimation performance, it is needed to indicate whether to raise pilot power or not.

Therefore, it is needed to design a new method for PDSCH transmission to indicate an adopted transmission manner, whether to raise pilot power or not and the like during PDSCH transmission which is considered as fallback operation, so as to improve reliability in PDSCH transmission and improve channel estimation performance of a receiver.

### SUMMARY

In view of this, the embodiments of the disclosure provide a method and system for PDSCH transmission and a network side device, so as to indicate an adopted transmission manner, whether to raise pilot power or not and the like during PDSCH transmission which is considered as fallback operation.

An embodiment of the disclosure provides a method for PDSCH transmission, which may include that:

a network side device determines a transmission parameter of a PDSCH according to information related to scheduled UE, the transmission parameter of the PDSCH including at least one of the following parameters: a transmission manner of the PDSCH, a power ratio of a reference signal corresponding to the PDSCH to data corresponding to the reference signal, and the information related to the scheduled UE including at least one of: Channel State Information (CSI) reported by the UE, a TM of the UE, version and support capability information of the UE, type information of a serving cell where the PDSCH is located and type information of a subframe where the PDSCH is located; and

the network side device performs resource mapping and sending according to the determined transmission parameter of the PDSCH.

Preferably, the method may further include that:

the network side device notifies the UE of the transmission parameter of the PDSCH.

Preferably, the step that the network side device notifies the UE of the transmission parameter of the PDSCH may include that: the transmission parameter of the PDSCH is notified to the UE through physical-layer downlink control signalling information and/or high-layer signalling information.

Preferably, the method may include that: the network side device predefines the transmission parameter of the PDSCH according to the information related to the scheduled UE.

Preferably, the resource mapping and sending may be performed for the PDSCH in at least one of manners as follows:

the PDSCH is mapped to one or multiple continuous Physical Resource Blocks (PRBs) of a same subframe, and the PDSCH adopts a single-DMRS antenna port-based TM;

or, the PDSCH is mapped to one or multiple continuous PRBs of a same subframe, and the PDSCH adopts a multi-DMRS antenna port-based TM;

or, the PDSCH is mapped to multiple continuous PRBs, the PRBs correspond to the same frequency-domain location within two timeslots of a same subframe, and the PDSCH adopts a single-DMRS antenna port-based TM;

or, the PDSCH is mapped to multiple discontinuous PRBs, the PRBs correspond to the same frequency-domain location within two timeslots of a same subframe, and the PDSCH adopts a multi-DMRS antenna port-based TM.

Preferably, the step that the PDSCH is mapped to the multiple discontinuous PRBs may include that:

discontinuous PRBs are distributed into n clusters, n is an integer larger than or equal to 1, and RBs included in each cluster are continuous.

Preferably, the multi-DMRS antenna port-based TM may include at least one of manners as follows:

DMRS-port-based Alamouti transmission diversity; antenna diversity based on different DMRS ports between REs in a PRB; DMRS-port-based Random Beam Forming (RBF); and a new multi-antenna TM using a DMRS as a basic DMRS.

Preferably, multi-DMRS antenna port-based selection in the multi-DMRS antenna port-based TM may include at least one of manners as follows:

two fixed DMRS ports are selected; and

each DMRS port group includes two DMRS ports, and one port group is selected from multiple DMRS port groups according to signalling.

Preferably, when the DMRS ports are selected, main Identities (IDs) and scrambling IDs during sequence initialization of the selected DMRS antenna ports are selected in at least one of manners as follows:

the scrambling IDs during sequence generation of the two DMRS ports adopt fixed values;

the scrambling IDs during sequence generation of the two DMRS ports are obtained by signalling configuration;

the main IDs during sequence generation of the two DMRS ports adopt a same Physical Cell ID (PCI);

the main IDs during sequence generation of the two DMRS ports adopt two fixed virtual IDs; and

the main IDs during sequence generation of the two DMRS ports are obtained by signalling configuration of two virtual IDs.

Preferably, the resource mapping of the PDSCH in the single-DMRS antenna port-based TM may include: resource mapping corresponding to a single antenna port, or, resource mapping corresponding to multiple antenna ports.

Preferably, the power ratio of the data corresponding to the reference signal may be a pilot-power-to-data-power ratio RS_EPRE/PDSCH_EPRE during transmission of the PDSCH, and a value of RS_EPRE/PDSCH_EPRE may be one of 1, 2 and ½, or may be one of 0 dB, 3 dB and −3 dB.

Preferably, the high-layer signalling information may include at least one of: system information obtained during initial access of the UE; and Radio Resource Control (RRC) configuration information obtained when the UE is in an RRC connection state.

Preferably, the method may include that:

the network side device indicates a corresponding transmission parameter of the PDSCH through a bit in an MIB in the high-layer signalling information;

or, the network side device indicates a corresponding transmission parameter of the PDSCH through UE-level RRC configuration information in the high-layer signalling information.

Preferably, the method may include that: the transmission manner of the PDSCH and/or the power ratio of the data corresponding to the reference signal are/is indicated in at least one of manners as follows:

a localized/distributed VRB indication bit in DCI Format 1A,

an available MCS indication bit,

a new bit in DCI Format 1A,

a DCI format corresponding to a newly defined TM,

a high-layer signalling information bit, and

a predefined manner.

Preferably, the TM of the UE may be TM10, or the newly defined TM;

the newly defined TM has characteristics as follows:

DCI formats corresponding to a TM may include DCI Format 1A and DCI Format 1, or may include DCI Format 1A and DCI Format 1 E;

the TM is a single-DMRS port-based TM and/or a diversity TM; and the diversity TM may include multi-port-based RBF and multi-port Space-Frequency Block Coding (SFBC).

The disclosure also provides a method for PDSCH transmission, which may include that:

UE receives data according to a transmission parameter, which is notified by a network side device, of a PDSCH, and/or determines a transmission parameter of a PDSCH according to information related to the UE and receives data according to the determined transmission parameter of the PDSCH, wherein

the transmission parameter of the PDSCH may include at least one of following parameters: a transmission manner of the PDSCH, a power ratio of a reference signal corresponding to the PDSCH to data corresponding to the reference signal; and

the information related to the UE may include at least one of: CSI reported by the UE, a TM of the UE, version and support capability information of the UE, type information of a serving cell where the PDSCH is located and type information of a subframe where the PDSCH is located.

Preferably, the method may further include that: the UE obtains the transmission parameter, which is notified by the network side device, of the PDSCH through physical-layer downlink control signalling information and/or high-layer signalling information.

Preferably, the high-layer signalling information may include at least one of: system information obtained during initial access of the UE, and RRC configuration information obtained when the UE is in an RRC connection state.

Preferably, the method may further include that:

the UE acquires a corresponding transmission parameter of the PDSCH through a bit in an MIB in the high-layer signalling information;

or, the UE acquires a corresponding transmission parameter of the PDSCH through UE-level RRC configuration information in the high-layer signalling information.

Preferably, the step that the UE obtains the transmission parameter of the PDSCH through the physical-layer downlink control signalling information may include that:

the transmission manner of the PDSCH and/or the power ratio of the data corresponding to the reference signal are/is obtained in at least one of manners as follows:

a localized/distributed VRB indication bit in DCI Format 1A,

an available MCS indication bit,

a new bit in DCI Format 1A,

a DCI format corresponding to a newly defined TM,

a high-layer signalling information bit, and

a predefined manner.

An embodiment of the disclosure further provides a network side device, which may include:

a parameter determination module, configured to determine a transmission parameter of a PDSCH according to information related to scheduled UE, the transmission parameter of the PDSCH including at least one of the following parameters: a transmission manner of the PDSCH, a power ratio of a reference signal corresponding to the PDSCH to data corresponding to the reference signal, and the information related to the scheduled UE including at least one of: CSI reported by the UE, a TM of the UE, version and support capability information of the UE, type information of a serving cell where the PDSCH is located and type information of a subframe where the PDSCH is located; and

a resource mapping and sending module, configured to perform resource mapping and sending according to the determined transmission parameter of the PDSCH.

Preferably, the network side device may further include: a parameter sending module, configured to notify the UE of the transmission parameter of the PDSCH.

Preferably, the parameter sending module may further be configured to notify the UE of the transmission parameter of the PDSCH through physical-layer downlink control signalling information and/or high-layer signalling information.

Preferably, the parameter determination module may be configured to predefine the transmission parameter of the PDSCH according to the information related to the scheduled UE.

Preferably, the resource mapping and sending may be performed for the PDSCH in at least one of manners as follows:

the PDSCH is mapped to one or multiple continuous PRBs of a same subframe, and the PDSCH adopts a single-DMRS antenna port-based TM;

or, the PDSCH is mapped to one or multiple continuous PRBs of a same subframe, and the PDSCH adopts a multi-DMRS antenna port-based TM;

or, the PDSCH is mapped to multiple continuous PRBs, the PRBs correspond to the same frequency-domain location within two timeslots of a same subframe, and the PDSCH adopts a single-DMRS antenna port-based TM;

or, the PDSCH is mapped to multiple discontinuous PRBs, the PRBs correspond to a same frequency-domain location within two timeslots of a same subframe, and the PDSCH adopts a multi-DMRS antenna port-based TM.

Preferably, the operation that the PDSCH is mapped to the multiple discontinuous PRBs may include that:

discontinuous PRB resources are distributed into n clusters, n is an integer larger than or equal to 1, and RBs included in each cluster are continuous.

Preferably, the multi-DMRS antenna port-based TM may include at least one of manners as follows:

DMRS-port-based Alamouti transmission diversity; antenna diversity based on different DMRS ports between REs in a PRB; DMRS-port-based RBF; and a new multi-antenna TM using a DMRS as a basic DMRS.

Preferably, multi-DMRS antenna port-based selection in the multi-DMRS antenna port-based TM may include at least one of manners as follows:

two fixed DMRS ports are selected; and

each DMRS port group includes two DMRS ports, and one port group is selected from multiple DMRS port groups according to signalling.

Preferably, when the DMRS ports are selected, main IDs and scrambling IDs during sequence initialization of the selected DMRS antenna ports may be selected in at least one of manners as follows:

the scrambling IDs during sequence generation of the two DMRS ports adopt fixed values;

the scrambling IDs during sequence generation of the two DMRS ports are obtained by signalling configuration;

the main IDs during sequence generation of the two DMRS ports adopt the same PCI;

the main IDs during sequence generation of the two DMRS ports adopt two fixed virtual IDs; and

the main IDs during sequence generation of the two DMRS ports are obtained by signalling configuration of two virtual IDs.

Preferably, the resource mapping of the PDSCH in the single-DMRS antenna port-based TM may include: resource mapping corresponding to a single antenna port, or, resource mapping corresponding to multiple antenna ports.

Preferably, the power ratio of the data corresponding to the reference signal may be a pilot-power-to-data-power ratio RS_EPRE/PDSCH_EPRE during transmission of the PDSCH, and a value of RS_EPRE/PDSCH_EPRE may be one of 1, 2 and ½, or may be one of 0 dB, 3 dB and −3 dB.

Preferably, the high-layer signalling information may include at least one of: system information obtained during initial access of the UE; and RRC configuration information obtained when the UE is in an RRC connection state.

Preferably, the resource mapping and sending module may be configured to indicate the transmission manner of the PDSCH and/or the power ratio of the data corresponding to the reference signal in at least one of manners as follows:

a localized/distributed VRB indication bit in DCI Format 1A,

an available MCS indication bit,

a new bit in DCI Format 1A,

a DCI format corresponding to a newly defined TM,

a high-layer signalling information bit, and

a predefined manner.

Preferably, the TM of the UE may be TM10, or the newly defined TM;

the newly defined TM has characteristics as follows:

DCI formats corresponding to a TM may include DCI Format 1A and DCI Format 1, or may include DCI Format 1A and DCI Format 1 E;

the TM is a single-DMRS port-based TM and/or a diversity TM; and the diversity TM may include multi-port-based RBF and multi-port Space-Frequency Block Coding (SFBC).

The disclosure further provides UE, which may include:

a transmission parameter acquisition module, configured to acquire a transmission parameter, which is notified by a network side device, of a PDSCH, or, determine a transmission parameter of a PDSCH according to information related to the UE; and

a data receiving module, configured to receive data according to the transmission parameter, which is notified by the network side device, of the PDSCH, and/or receive data according to the transmission parameter, which is determined by the transmission parameter acquisition module, of the PDSCH, wherein

the transmission parameter of the PDSCH may include at least one of the following parameters: a transmission manner of the PDSCH, a power ratio of a reference signal corresponding to the PDSCH to data corresponding to the reference signal; and

the information related to the UE may include at least one of: CSI reported by the UE, a TM of the UE, version and support capability information of the UE, type information of a serving cell where the PDSCH is located and type information of a subframe where the PDSCH is located.

Preferably, the transmission parameter acquisition module may be configured to obtain the transmission parameter, which is notified by the network side device, of the PDSCH through physical-layer downlink control signalling information and/or high-layer signalling information.

Preferably, the high-layer signalling information may include at least one of: system information obtained during initial access of the UE; and RRC configuration information obtained when the UE is in an RRC connection state.

Preferably, the transmission parameter acquisition module may be configured to acquire a corresponding transmission parameter of the PDSCH through a bit in an MIB in the high-layer signalling information; or, acquire a corresponding transmission parameter of the PDSCH through UE-level RRC configuration information in the high-layer signalling information.

Preferably, the operation that the transmission parameter acquisition module obtains the transmission parameter of the PDSCH through the physical-layer downlink control signalling information may include that:

the transmission manner of the PDSCH and/or the power ratio of the data corresponding to the reference signal are/is obtained in at least one of manners as follows:

a localized/distributed VRB indication bit in DCI Format 1A,

an available MCS indication bit,

a new bit in DCI Format 1A,

a DCI format corresponding to a newly defined TM,

a high-layer signalling information bit, and

a predefined manner.

An embodiment of the disclosure further provides a system for PDSCH transmission, which may include the network side device in the abovementioned embodiment and the UE in the abovementioned embodiment.

An embodiment of the disclosure further provides a computer-readable storage medium, which may include a set of computer-executable instructions, the instructions being configured to execute a method for PDSCH transmission for a network side device.

An embodiment of the disclosure further provides a computer-readable storage medium, which may include a set of computer-executable instructions, the instructions being configured to execute a method for PDSCH transmission for a UE side.

According to the method and system for PDSCH transmission and a network side device provided by the embodiments of the disclosure, an adopted transmission manner, whether to raise pilot power or not and the like during PDSCH transmission considered as fallback operation are indicated, reliability in PDSCH transmission is improved, and channel estimation performance of a receiver is improved.

### BRIEF DESCRIPTION OF THE DRAWINGS

FIG. 1 is a flowchart of a method for PDSCH transmission according to an embodiment of the disclosure;

FIG. 2 is a diagram of mapping of a PDSCH to multiple discontinuous PRBs according to an embodiment of the disclosure;

FIG. 3 is a diagram of distribution of REs in a PRB of a PDSCH according to an embodiment of the disclosure;

FIG. 4 is a structure diagram of a network side device according to an embodiment of the disclosure; and

FIG. 5 is a structure diagram of UE according to an embodiment of the disclosure.

### DETAILED DESCRIPTION

The technical solutions of the disclosure will be further described below with reference to the drawings and specific embodiments in detail.

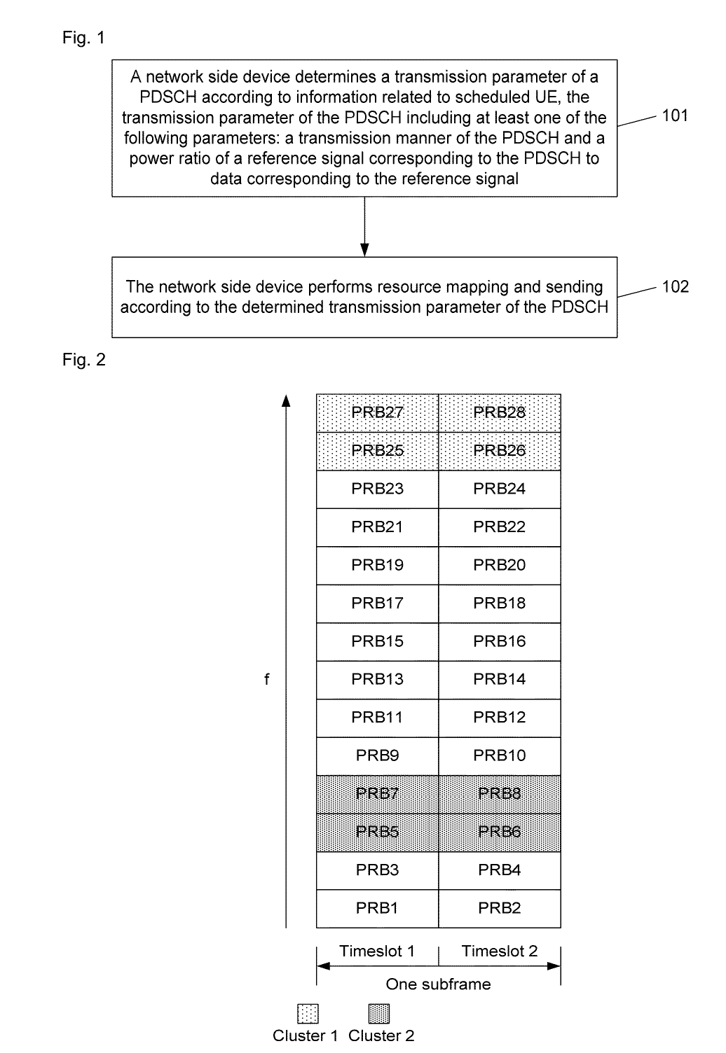

A method for PDSCH transmission provided by an embodiment of the disclosure, as shown in FIG. 1, mainly includes:

step 101: a network side device determines a transmission parameter of a PDSCH according to information related to scheduled UE, the transmission parameter of the PDSCH including at least one of the following parameters: a transmission manner of the PDSCH, a reference signal corresponding to the PDSCH, and a power ratio (i.e. a value of RS_EPRE/PDSCH_EPRE) of data corresponding to the reference signal, and RS_EPRE/PDSCH_EPRE referring to a ratio of pilot power to data power during PDSCH transmission; and

step 102: the network side device performs resource mapping and sending according to the determined transmission parameter of the PDSCH.

Preferably, the network side device may notify the UE of the transmission parameter of the PDSCH; and

the UE receives data according to the transmission parameter, which is notified by the network side device, of the PDSCH, and/or determines the transmission parameter of the PDSCH according to information related to the UE and receives data according to the determined transmission parameter of the PDSCH.

The network side device may notify the UE of the transmission parameter of the PDSCH through physical-layer downlink control signalling information and/or high-layer signalling information. Correspondingly, the UE obtains the transmission parameter, which is notified by the network side device, of the PDSCH through the physical-layer downlink control signalling information and/or the high-layer signalling information.

Preferably, the network side device predefines the transmission parameter of the PDSCH according to the information related to the scheduled UE.

Preferably, the information related to the scheduled UE includes at least one of: CSI reported by the UE, a TM of the UE, version and support capability information of the UE, type information (New Carrier Type (NCT) or Backward Compatible Carrier Type (BCT)) of a serving cell where the PDSCH is located, and type information (whether there is a CRS transmitted in a current subframe or not, RCRS, and a Multicast Broadcast Single Frequency Network (MBSFN) subframe) of a subframe wherein the PDSCH is located. Here, the TM of the UE is preferably a mode such as TM1-TM10, and also includes a new TM which is subsequently defined; the UE mainly acquires TM information through high-layer signalling, and the newly defined TM has characteristics as follows:

DCI formats corresponding to a TM include DCI Format 1A and DCI Format 1, or include DCI Format 1A and DCI Format 1E; and

the TM is a single-DMRS port-based TM and/or a diversity TM, and furthermore, the diversity TM include multi-port-based RBF and multi-port-based SFBC.

In an NCT, the TM supported by the UE is preferably TM10 and the newly defined TM;

moreover, different TMs are defined according to different carrier types, for example, a mode such as TM1-TM10 is preferably supported in a BCT, and TM10 and the newly defined TM are preferably supported in the NCT;

for example, if the CSI reported by the UE shows that a channel condition is poor, a version of the UE is UE supporting the NCT, the type of a serving cell where the UE is located is the NCT, the TM configured for the UE is TM10 or the newly defined TM, and no CRS or only an RCRS is transmitted in the subframe where the PDSCH is located, then the network side device determines that DCI Format 1A and a single-DMRS or multi-DMRS port-based PDSCH transmission manner are adopted and determines a resource mapping manner mentioned below and the value of RS_EPRE/PDSCH_EPRE;

or, if the CSI reported by the UE shows that the channel condition is poor, the version of the UE is UE supporting the BCT, the type of the serving cell where the UE is located is the BCT, the TM configured for the UE is TM10 or the newly defined TM, and the subframe where the PDSCH is located is the MBSFN subframe, then the network side device determines that DCI Format 1A and single-DMRS port-based transmission manner and resource mapping manner are adopted, and sets the value of RS_EPRE/PDSCH_EPRE to be 1, or represents the value with 0 dB in a dB form;

or, if the CSI reported by the UE shows that the channel condition is poor, the version of the UE is UE supporting the BCT, the type of the serving cell where the UE is located is the BCT, the TM configured for the UE is TM10 or TM9, and a CRS is transmitted in the subframe where the PDSCH is located, then the network side device determines that DCI Format 1A and a CRS-based single-port or transmission diversity manner and resource mapping manner are adopted, and sets the value of RS_EPRE/PDSCH_EPRE to be 1, or represents the value with 0 dB in a dB form.

Preferably, the manner of resource mapping and sending for the PDSCH includes at least one of manners as follows:

the PDSCH is mapped to one or multiple continuous PRBs of the same subframe, and the PDSCH adopts a single-DMRS antenna port-based TM;

or, the PDSCH is mapped to one or multiple continuous PRBs of the same subframe, and the PDSCH adopts a multi-DMRS antenna port-based TM;

or, the PDSCH is mapped to multiple discontinuous PRBs, the PRBs correspond to the same frequency-domain location within two timeslots of the same subframe, and the PDSCH adopts the single-DMRS antenna port-based TM;

or, the PDSCH is mapped to multiple discontinuous PRBs, the PRBs correspond to the same frequency-domain location within two timeslots of the same subframe, and the PDSCH adopts the multi-DMRS antenna port-based TM.

Here, the operation that the PDSCH is mapped to the multiple discontinuous PRBs includes that: discontinuous PRB resources are distributed and limited into n clusters, n is an integer larger than or equal to 1, and preferably n is 2; the RBs included in each cluster are continuous; and each cluster includes one or multiple RBs, or, each cluster includes one or multiple continuous Resource Block Groups (RBGs), wherein each cluster preferably includes one or multiple continuous RBGs.

When the abovementioned preferred mapping method for discontinuous PRBs is adopted, the first and last RBGs of two distributed clusters may be instructed through signalling to indicate the distributed discontinuous PRB resources here.

In the embodiment of the disclosure, one RBG includes P RBs, wherein a value of P is taken according to a function of a downlink system bandwidth N_{RB}^{DL}, as shown in Table 2:

TABLE 2

| Downlink system bandwidth N_{RB}^{DL} | RBG Size (P) |
|---|---|
| ≦10 | 1 |
| 11-26 | 2 |
| 27-36 | 3 |
| 64-110 | 4 |

Or, the discontinuous PRB resources are distributed and limited into n clusters, n is an integer larger than or equal to 1, each cluster includes the same number of RBs, and the RBs included in each cluster are continuous; cluster intervals are selected as equal intervals, or are selected randomly, or are selected according to fed back sub-band CSI;

or, the discontinuous PRB resources are distributed and limited into n clusters, and n is an integer larger than or equal to 1; each cluster includes different numbers of RBs, and the RBs included in each cluster are continuous; the cluster intervals are selected as equal intervals, or are selected randomly, or are selected according to fed back sub-band CSI;

or, the discontinuous PRB resources are distributed and limited into n clusters, and n is an integer larger than or equal to 1; each cluster includes the same number of RBs, and the RBs included in each cluster are discontinuous; the cluster intervals are selected as equal intervals, or are selected randomly, or are selected according to fed back sub-band CSI;

or, the discontinuous PRB resources are distributed and limited into n clusters, and n is an integer larger than or equal to 1; each cluster includes different numbers of RBs, and the RBs included in each cluster are discontinuous; the cluster intervals are selected as equal intervals, or are selected randomly, or are selected according to fed back sub-band CSI;

or, n PRBs at equal intervals are distributed during distribution of the discontinuous PRB resources.

Resource mapping of the PDSCH in the single-DMRS antenna port-based TM may include: resource mapping corresponding to a single antenna port, or, resource mapping corresponding to multiple antenna ports.

A DMRS sequence is generated as follows:

$$r ( m ) = \frac{1}{\sqrt{2}} ( 1 - 2 \cdot c ( 2 m ) + j \frac{1}{\sqrt{2}} ( 1 - 2 \cdot c ( 2 m + 1 ) , \\ m = \{ \begin{matrix}0 , 1 , … , 12 {N}_{RB}^{max , DL} - 1 & normal cyclic prefix \\ 0 , 1 , … , 16 {N}_{RB}^{max , DL} - 1 & extended cyclic prefix\end{matrix}$$

where an initial sequence of c(i) is defined as:

cᵢₙᵢₜ=(└nₛ/2┘+1)·(2n_{ID}⁽ⁿ^{_{SCID}}⁾+1)·2¹⁶+n_{SCID}, n_{ID}⁽ⁿ^{_{SCID}}⁾ represents a main ID, and n_{SCID} represents a scrambling ID;

n_{ID}⁽ⁿ^{_{SCID}}⁾ may adopt a physical cell identity (PCI) or a virtual cell ID, where a value range of the virtual cell ID is [0, 503], and inter-node orthogonality may be achieved by configuring different virtual cells in the same PCI;

parameter selection related to the multi-DMRS antenna port-based TM includes at least one of manners as follows:

Manner 1: two fixed DMRS ports are selected, for example, port 7 and port 9 are fixedly selected, or port 8 and port 10 are fixedly selected, or port 7 and port 8 are fixedly selected, or two fixedly selected ports are from a port group (107, 108, 109, 110), or two fixedly selected ports are from a newly defined DMRS port group; when two fixed DMRS ports are selected, it is also needed to consider the Cyclic Prefix (CP) type of a subframe; and

Manner 2: one port group (each DMRSs port group includes two DMRS ports) is selected from multiple DMRS port groups according to signalling, the DMRS port groups are obtained from a DMRS port set (7, 8, 9, 10), or are obtained from a port set (107, 108, 109, 110), or are obtained from a newly defined DMRS port set, and the required indication signalling is a physical-layer signalling indication or a high-layer signalling indication.

Here, when the DMRS ports are selected, main IDs and scrambling IDs during sequence initialization of the selected DMRS antenna ports are selected in at least one of manners as follows:

1: n_{SCID} adopts a fixed value during sequence generation of the two DMRS ports, and a value range is {0, 1}; the scrambling IDs adopt the same value or adopt different values during sequence generation of the two DMRS ports;

2: n_{SCID} is obtained by signalling configuration during sequence generation of the two DMRS ports, and the value range of the scrambling IDs is {0, 1}; the required scrambling IDs are obtained through physical-layer signalling or high-layer signalling indication;

3: n_{ID}⁽ⁿ^{_{SCID}}⁾ adopts the same PCI during sequence generation of the two DMRS ports;

4: n_{ID}⁽ⁿ^{_{SCID}}⁾ adopts two fixed virtual IDs during sequence generation of the two DMRS ports, the virtual IDs are integers, a value range is (0, n], n is a positive integer larger than or equal to 1, and n is preferably 503; the two virtual IDs may adopt the same value or adopt different values;

5: n_{ID}⁽ⁿ^{_{SCID}}⁾ during sequence generation of the two DMRS ports is obtained by signalling configuration of two virtual IDs, the virtual IDs are integers, a value range is (0, n], n is a positive integer larger than or equal to 1, and n is preferably 503; and the required virtual IDs are obtained through physical-layer signalling or a high-layer signalling indication.

Preferably, the multi-DMRS antenna port-based TM includes at least one of manners as follows:

DMRS-port-based Alamouti transmission diversity; antenna diversity based on different DMRS ports between REs in a PRB; DMRS-port-based RBF; and a new multi-antenna TM using a DMRS as a basic DMRS.

Preferably, the transmission manner of the PDSCH may be indicated through a physical-layer control signalling bit and/or a high-layer signalling information bit,

wherein the physical-layer control signalling includes DCI Format 1A and newly added DCI Format 1 E and/or DCI Format 1F, or may be a DCI format corresponding to the newly defined TM; and the high-layer signalling information includes at least one of: system information obtained during initial access of the UE, and RRC configuration information obtained when the UE is in an RRC connection state.

An available signalling bit in the physical-layer control signalling, for example, DCI Format 1A, includes: a localized/distributed VRB bit, and/or an available MCS indication bit, and/or a new added bit in DCI Format 1A; and

the step that the transmission parameter of the PDSCH is obtained through the high-layer signalling information includes that: the corresponding transmission parameter of the PDSCH is acquired through a bit in an MIB in the high-layer signalling information; or, the corresponding transmission parameter of the PDSCH is acquired through UE-level RRC configuration information in the high-layer signalling information.

The transmission manner of the PDSCH is indicated through the physical-layer control signalling bit and/or the high-layer signalling information bit; the transmission manner of the PDSCH includes two states, and the state to be selected is indicated through the physical-layer control signalling bit and/or the high-layer signalling information bit, and a state set of the transmission manner of the PDSCH includes at least one of sets listed in Table 3:

TABLE 3

| set | State 1 | State 2 |
|---|---|---|
| 1 | Single-DMRS antenna port | DMRS-port-based Alamouti transmission |
| | | diversity |
| 2 | Single-DMRS antenna port | Antenna diversity based on different |
| | | DMRS ports between REs in a PRB |
| 3 | Single-DMRS antenna port | DMRS-port-based RBF |
| 4 | Single-DMRS antenna port | Multi-antenna TM using a DMRS as a |
| | | basic DMRS in a more advanced version |
| 5 | DMRS-port-based Alamouti | Antenna diversity based on different |
| | transmission diversity | DMRS ports between REs in a PRB |
| 6 | DMRS-port-based Alamouti | DMRS-port-based RBF |
| | transmission diversity | |
| 7 | DMRS-port-based Alamouti | Multi-antenna TM using a DMRS as a |
| | transmission diversity | basic DMRS in a more advanced version |
| 8 | Antenna diversity based on different | DMRS-port-based RBF |
| | DMRS ports between REs in a PRB | |
| 9 | Antenna diversity based on different | Multi-antenna TM using a DM-RS as a |
| | DMRS ports between REs in a PRB | basic DMRS in a more advanced version |
| 10 | DMRS-port-based RBF | Multi-antenna TM using a DMRS as a |
| | | basic DMRS in a more advanced version |

The value of RS_EPRE/PDSCH_EPRE may also be indicated through a physical-layer control signalling bit and/or a high-layer signalling information bit,

wherein the physical-layer control signalling includes DCI Format 1A and newly added DCI Format 1 E and/or DCI Format 1F, or may be a DCI format corresponding to the newly defined TM; and the high-layer signalling information includes at least one of: the system information obtained during initial access of the UE, and the RRC configuration information obtained when the UE is in a RRC connection state.

The available signalling bit in the physical-layer control signalling, for example, DCI Format 1A, includes: a localized/distributed VRB bit, and/or an available MCS indication bit, and/or a new added bit in DCI Format 1A; and

the step that the transmission parameter of the PDSCH is acquired through the high-layer signalling information includes that: the corresponding transmission parameter of the PDSCH is acquired through the bit in the MIB; or, the corresponding transmission parameter of the PDSCH is acquired through UE-level RRC configuration information.

The step that the transmission parameter of the PDSCH is obtained through the physical-layer downlink control signalling information includes that: the transmission manner of the PDSCH and/or the power ratio of the data corresponding to the reference signal are/is obtained in at least one of manners as follows:

a localized/distributed VRB indication bit in DCI Format 1A,

an available MCS indication bit,

a new bit in DCI Format 1A,

a DCI format corresponding to the newly defined TM,

a high-layer signalling information bit, and

a predefined manner.

Preferably, the value of RS_EPRE/PDSCH_EPRE is one of 1, 2 and ½, or is one of 0 dB, 3 dB and −3 dB.

Here, the value of RS_EPRE/PDSCH_EPRE may also be distinguished into the following 6 states (W1-W6):

W1 is set to represent that 2 or more DMRS port locations are generated, but only one DMRS port location therein is adopted for DMRS sequence mapping, REs of the other DMRS port locations are adopted to transmit data, power raising is not performed on RE locations which are for transmitting DMRS sequences, and then the value of RS_EPRE/PDSCH_EPRE is 1, i.e. 0 dB;

W2 is set to represent that 2 or more DMRS port locations are generated, but only one DMRS port location therein is adopted for DMRS sequence mapping, REs of the other DMRS port locations are adopted to transmit data, power raising is performed on RE locations which are for transmitting DMRS sequences, and then the value of RS_EPRE/PDSCH_EPRE is 2, i.e. 3 dB;

W3 is set to represent that 2 or more DMRS port locations are generated, but only one DMRS port location therein is adopted for DMRS sequence mapping, REs of the other DMRS port locations are adopted to transmit data, power reduction is performed on RE locations which are for transmitting DMRS sequences, and then the value of RS_EPRE/PDSCH_EPRE is ½, i.e. −3 dB;

W4 is set to represent that 2 or more DMRS port locations are generated, but only one DMRS port location therein is adopted for DMRS sequence mapping, REs of the other DMRS port locations are idle, power raising is not performed on RE locations which are for transmitting DMRS sequences, and then the value of RS_EPRE/PDSCH_EPRE is 1, i.e. 0 dB;

W5 is set to represent that 2 or more DMRS port locations are generated, but only one DMRS port location therein is adopted for DMRS sequence mapping, REs of the other DMRS port locations are idle, power raising is performed on RE locations which are for transmitting DMRS sequences, and then the value of RS_EPRE/PDSCH_EPRE is 2, i.e. 3 dB; and

W6 is set to represent that 2 or more DMRS port locations are generated, but only one DMRS port location therein is adopted for DMRS sequence mapping, REs of the other DMRS port locations are idle, power reduction is performed on RE locations which are for transmitting DMRS sequences, and then the value of RS_EPRE/PDSCH_EPRE is ½, i.e. −3 dB.

The state of the value of RS_EPRE/PDSCH_EPRE is indicated through the physical-layer control signalling bit and/or the high-layer signalling information bit, the indicated state is selected from a state set formed by two states, and an indicated state combination of the value of RS_EPRE/PDSCH_EPRE includes at least one of:

(W1, W2); or (W1, W3); or (W1, W4); or (W1, W5); or (W1, W6); or (W2, W3); or (W2, W4); or (W2, W5); or (W2, W6); or (W3, W4); or (W3, W5); or (W3, W6); or (W4, W5); or (W4, W6); or (W5, W6).

In addition, the transmission parameter, predefined by the network side device, of the PDSCH includes at least one of:

parameter 1: the resource mapping manner for the PDSCH:

it is predefined that the PDSCH is mapped to one or multiple continuous PRBs of the same subframe;

or, it is predefined that the PDSCH is mapped to multiple discontinuous PRBs and the PRBs correspond to the same frequency-domain location within two timeslots of the same subframe;

or, it is predefined that the PDSCH is mapped to discontinuous PRB resources, the PRBs correspond to the same frequency-domain location within two timeslots of the same subframe, the discontinuous PRB resources are distributed and limited into n clusters and n is an integer larger than or equal to 1; and the RBs included in each cluster are continuous, each cluster includes one or multiple RBs, or, each cluster includes one or multiple continuous RBGs, wherein each cluster preferably includes one or multiple continuous RBGs.

When the abovementioned preferred mapping method for discontinuous PRBs is adopted, the first and last RBGs of the two distributed clusters may be instructed to indicate the distributed discontinuous PRB resources here.

In the embodiment of the disclosure, one RBG includes P RBs, wherein the value of P is taken according to the function of the downlink system bandwidth, N_{RB}^{DL}, as shown in Table 2.

Or, it is predefined that the PDSCH is mapped to discontinuous PRB resources, the PRBs correspond to the same frequency-domain location within two timeslots of the same subframe, the discontinuous PRB resources are distributed and limited into n clusters, and n is an integer larger than or equal to 1; each cluster includes the same number of RBs, and the RBs included in each cluster are continuous; the cluster intervals are selected to be equal intervals, or are randomly selected, or are selected according to the fed back sub-band CSI;

or, it is predefined that the PDSCH is mapped to discontinuous PRB resources, the PRBs correspond to the same frequency-domain location within two timeslots of the same subframe, the discontinuous PRB resources are distributed and limited into n clusters, and n is an integer larger than or equal to 1; each cluster includes different numbers of RBs, and the RBs included in each cluster are continuous; the cluster intervals are selected to be equal intervals, or are randomly selected, or are selected according to the fed back sub-band CSI;

or, it is predefined that the PDSCH is mapped to discontinuous PRB resources, the PRBs correspond to the same frequency-domain location within two timeslots of the same subframe, the discontinuous PRB resources are distributed and limited into n clusters, and n is an integer larger than or equal to 1; each cluster includes the same number of RBs, and the RBs included in each cluster are discontinuous; the cluster intervals are selected to be equal intervals, or are randomly selected, or are selected according to the fed back sub-band CSI;

or, it is predefined that the PDSCH is mapped to discontinuous PRB resources, the PRBs correspond to the same frequency-domain location within two timeslots of the same subframe, the discontinuous PRB resources are distributed and limited into n clusters, and n is an integer larger than or equal to 1; each cluster includes different numbers of RBs, and the RBs included in each cluster are discontinuous; the cluster intervals are selected to be equal intervals, or are randomly selected, or are selected according to the fed back sub-band CSI;

or, it is predefined that the PDSCH is mapped to discontinuous PRB resources, the PRBs correspond to the same frequency-domain location within two timeslots of the same subframe, n PRBs at equal intervals are distributed during distribution of the discontinuous PRB resources.

Parameter 2: the sending manner of the PDSCH:

it is predefined that a single-DMRS antenna port-based TM is adopted for the PDSCH;

or, DMRS-port-based Alamouti transmission diversity is adopted;

or, antenna diversity based on different DMRS ports between REs in a PRB is adopted;

or, DMRS-port-based RBF is adopted;

or, a multi-antenna TM using a DMRS as a basic DMRS in a more advanced version is adopted.

Parameter 3: the pilot-power-to-data-power ratio during transmission of the PDSCH, i.e. the value of RS_EPRE/PDSCH_EPRE:

it is predefined that 2 or more DMRS port locations are generated, but only one DMRS port location therein is adopted for DMRS sequence mapping, REs of the other DMRS port locations are adopted to transmit data, power raising is not performed on RE locations which are for transmitting DMRS sequences, and then the power ratio of the reference signal to the data corresponding to the reference signal is 1, i.e. 0 dB;

or, it is predefined that 2 or more DMRS port locations are generated, but only one DMRS port location therein is adopted for DMRS sequence mapping, REs of the other DMRS port locations are adopted to transmit data, power raising is performed on RE locations which are for transmitting DMRS sequences, and then the power ratio of the reference signal to the data corresponding to the reference signal is 2, i.e. 3 dB;

or, it is predefined that 2 or more DMRS port locations are generated, but only one DMRS port location therein is adopted for DMRS sequence mapping, REs of the other DMRS port locations are adopted to transmit data, power reduction is performed on RE locations which are for transmitting DMRS sequences, and then the power ratio of the reference signal to the data corresponding to the reference signal is ½, i.e. −3 dB;

or, it is predefined that 2 or more DMRS port locations are generated, but only one DMRS port location therein is adopted for DMRS sequence mapping, REs of the other DMRS port locations are idle, power raising is not performed on RE locations which are for transmitting DMRS sequences, and then the power ratio of the reference signal to the data corresponding to the reference signal is 1, i.e. 0 dB;

or, it is predefined that 2 or more DMRS port locations are generated, but only one DMRS port location therein is adopted for DMRS sequence mapping, REs of the other DMRS port locations are idle, power raising is performed on RE locations which are for transmitting DMRS sequences, and then the power ratio of the reference signal to the data corresponding to the reference signal is 2, i.e. 3 dB; and

or, it is predefined that 2 or more DMRS port locations are generated, but only one DMRS port location therein is adopted for DMRS sequence mapping, REs of the other DMRS port locations are idle, power reduction is performed on RE locations which are for transmitting DMRS sequences, and then the power ratio of the reference signal to the data corresponding to the reference signal is ½, i.e. −3 dB.

The solution of the disclosure is applicable to a PDSCH of a new carrier, and is also applicable to a PDSCH of CoMP and to transmission of a PDSCH of Machine Type Communication (MTC), relay and the like; the PDSCH may be located in a licensed spectrum, or may also be located in an unlicensed spectrum; and in order to facilitate description, only an implementation mode for a PDSCH of an NCT in a licensed spectrum is listed, and implementation in other scenarios may be obtained with reference to the implementation mode.

The technical solution of the disclosure will be described with reference to specific embodiments in detail.

It is to be noted that even though the embodiments of the disclosure only illustrate a PDSCH of a new carrier, the embodiments are also applicable to a PDSCH of CoMP, and transmission of a PDSCH of MTC, relay and the like also falls within the scope of protection of the embodiments of the disclosure.

### Embodiment 1

A network side device transmits data by an NCT, the transmitted data corresponds to a single TB, and the network side device determines a transmission parameter of a PDSCH according to channel state indication information reported by UE in combination with a TM of the UE, version and support capability information of the UE, type information of a serving cell where the PDSCH is located and type information of a subframe where the PDSCH is located; and if the version of the UE is UE supporting the NCT, the type of the serving cell where the UE is located is the NCT, the TM configured for the UE is TM10 or TM9 and no CRS or only an RCRS is transmitted in the subframe where the PDSCH is located, then a single-DMRS antenna port-based transmission manner is adopted, resource mapping corresponding to a single DMRS antenna port is performed, a power ratio of a reference signal corresponding to the PDSCH to data corresponding to the reference signal is indicated through a localized/distributed VRB indication bit in physical-layer control signalling DCI Format 1A, and/or through an available MCS indication bit and/or through a high-layer signalling information bit, the power ratio of the reference signal corresponding to the PDSCH to the data corresponding to the reference signal specifically is one of 1, 2 and ½, and the PDSCH is mapped to one or multiple continuous PRBs of the same subframe.

### Embodiment 2

A network side device transmits data by an NCT, the transmitted data corresponds to a single TB, and the network side device determines a transmission parameter of a PDSCH according to channel state indication information reported by UE in combination with a TM of the UE, version and support capability information of the UE, type information of a serving cell where the PDSCH is located and type information of a subframe where the PDSCH is located; if the version of the UE is UE supporting the NCT, the type of the serving cell where the UE is located is the NCT, the TM configured for the UE is TM10 or TM9 and no CRS or only an RCRS is transmitted in the subframe where the PDSCH is located, then a single-DMRS antenna port-based transmission manner is adopted, resource mapping corresponding to a single DMRS antenna port is performed, a power ratio of a reference signal corresponding to the PDSCH to data corresponding to the reference signal is indicated through a localized/distributed VRB indication bit in physical-layer control signalling DCI Format 1A, and/or through an available MCS indication bit and/or through a high-layer signalling information bit, the power ratio of the reference signal corresponding to the PDSCH to the data corresponding to the reference signal specifically is one of 1, 2 and ½, the PDSCH is mapped to multiple discontinuous PRBs of the same subframe, and the PRBs correspond to the same frequency-domain location within two timeslots of the same subframe; the discontinuous PRB resources are distributed and limited into n clusters, and n is an integer larger than or equal to 1; and the RBs included in each cluster are continuous, each cluster includes one or multiple RBs, or, each cluster includes one or multiple continuous RBGs, wherein each cluster preferably includes one or multiple continuous RBGs.

When the abovementioned preferred mapping method for discontinuous PRBs is adopted, the first and last RBGs of the two distributed clusters may be indicated to indicate the distributed discontinuous PRB resources here.

At this time, one RBG includes P RBs, wherein a value of P is taken according to a function of a downlink system bandwidth N_{RB}^{DL}, as shown in Table 2.

### Embodiment 3

A network side device transmits data by an NCT, the transmitted data corresponds to a single TB, and the network side device determines a transmission parameter of a PDSCH according to channel state indication information reported by UE in combination with a TM of the UE, version and support capability information of the UE, type information of a serving cell where the PDSCH is located and type information of a subframe where the PDSCH is located; and if the version of the UE is UE supporting the NCT, the type of the serving cell where the UE is located is the NCT, the TM configured for the UE is TM10 or TM9 and no CRS or only an RCRS is transmitted in the subframe where the PDSCH is located, then a single-DMRS antenna port-based transmission manner is adopted, mapping is performed according to resources corresponding to multiple DMRS ports, for example, if DMRS ports are (7, 8, 9, 10), only one DMRS port location therein is adopted for DMRS sequence mapping, REs of the other DMRS port locations are adopted to transmit the data and PDSCH REs except the REs of the DMRS port locations are adopted for mapping, a power ratio of a reference signal corresponding to the PDSCH to data corresponding to the reference signal is indicated through a localized/distributed VRB indication bit in physical-layer control signalling DCI Format 1A, and/or through an available MCS indication bit and/or through a high-layer signalling information bit, the power ratio of the reference signal corresponding to the PDSCH to the data corresponding to the reference signal is one of 1, 2 and ½, and the PDSCH is mapped to one or multiple continuous PRBs of the same subframe.

### Embodiment 4

A network side device transmits data by an NCT, the transmitted data corresponds to a single TB, and the network side device determines a transmission parameter of a PDSCH according to channel state indication information reported by UE in combination with a TM of the UE, version and support capability information of the UE, type information of a serving cell where the PDSCH is located and type information of a subframe where the PDSCH is located; and if the version of the UE is UE supporting the NCT, the type of the serving cell where the UE is located is the NCT, the TM configured for the UE is TM10 or TM9 and no CRS or only an RCRS is transmitted in the subframe where the PDSCH is located, a single-DMRS antenna port-based transmission manner is adopted, mapping is performed according to resources corresponding to multiple DMRS ports, for example, if DMRS ports are (7, 8, 9, 10), only one DMRS port location therein is adopted for DMRS sequence mapping, REs of the other DMRS port locations are idle and PDSCH REs except the REs of the DMRS port locations are adopted for mapping, a power ratio of a reference signal corresponding to the PDSCH to data corresponding to the reference signal is indicated through a localized/distributed VRB indication bit in physical-layer control signalling DCI Format 1A, and/or through an available MCS indication bit and/or through a high-layer signalling information bit, the power ratio of the reference signal corresponding to the PDSCH to the data corresponding to the reference signal is one of 1, 2 and ½, and the PDSCH is mapped to one or multiple continuous PRBs of the same subframe.

### Embodiment 5

A network side device transmits data by an NCT, the transmitted data corresponds to a single TB, and the network side device determines a transmission parameter of a PDSCH according to channel state indication information reported by UE in combination with a TM of the UE, version and support capability information of the UE, type information of a serving cell where the PDSCH is located and type information of a subframe where the PDSCH is located; and if the version of the UE is UE supporting the NCT, the type of the serving cell where the UE is located is the NCT, the TM configured for the UE is TM10 or TM9 and no CRS or only an RCRS is transmitted in the subframe where the PDSCH is located, then a single-DMRS antenna port-based transmission manner is adopted, a power ratio of a reference signal corresponding to the PDSCH to data corresponding to the reference signal is indicated through a localized/distributed VRB indication bit in physical-layer control signalling DCI Format 1A, and/or through an available MCS indication bit and/or through a high-layer signalling information bit, and the following two states are distinguished through a bit indication:

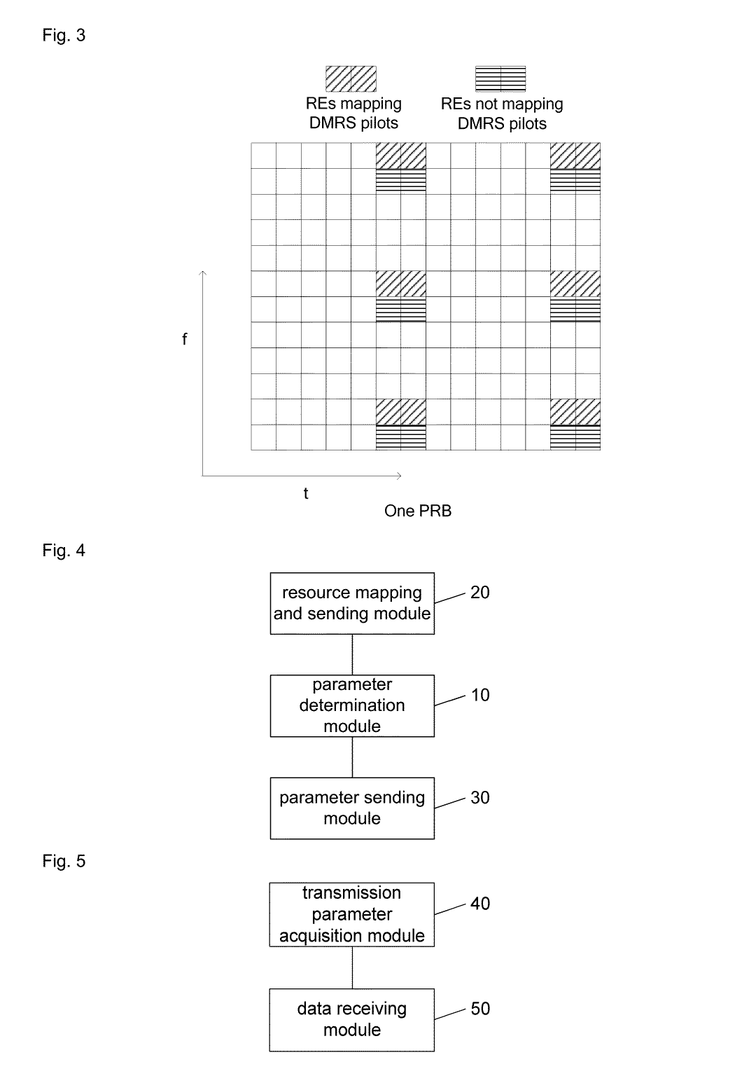

state 1: mapping is performed according to resources corresponding to multiple DMRS ports, for example, if DMRS ports are (7, 8, 9, 10), only one DMRS port location therein is adopted for DMRS sequence mapping, REs of the other DMRS port locations are idle, as shown in FIG. 3, PDSCH REs except the REs of the DMRS port locations are adopted for mapping;

state 2: mapping is performed according to resources corresponding to multiple DMRS ports, for example, if the DMRS ports are (7, 8, 9, 10), only one DMRS port location therein is adopted for DMRS sequence mapping and the REs of the other DMRS port locations and the other PDSCH REs are adopted for data mapping; and

the power ratio of the reference signal corresponding to the PDSCH to the data corresponding to the reference signal is one of 1, 2 and ½, and the PDSCH is mapped to one or multiple continuous PRBs of the same subframe.

### Embodiment 6

A network side device transmits data by an NCT, the transmitted data corresponds to a single TB, and the network side device determines a transmission parameter of a PDSCH according to channel state indication information reported by UE in combination with a TM of the UE, version and support capability information of the UE, type information of a serving cell where the PDSCH is located and type information of a subframe where the PDSCH is located; if the version of the UE is UE supporting the NCT, the type of the serving cell where the UE is located is the NCT, the TM configured for the UE is TM10 or TM9 and no CRS or only an RCRS is transmitted in the subframe where the PDSCH is located, then a single-DMRS antenna port-based transmission manner is adopted, mapping is performed according to resources corresponding to multiple DMRS ports, for example, if DMRS ports are (7, 8, 9, 10), only one DMRS port location therein is adopted for DMRS sequence mapping, REs of the other DMRS port locations are adopted to transmit the data and PDSCH REs except the REs of the DMRS port locations are adopted for mapping, a power ratio of a reference signal corresponding to the PDSCH to data corresponding to the reference signal is indicated through a localized/distributed VRB indication bit in physical-layer control signalling DCI Format 1A, and/or through an available MCS indication bit and/or through a high-layer signalling information bit, the power ratio of the reference signal corresponding to the PDSCH to the data corresponding to the reference signal is one of 1, 2 and ½, the PDSCH is mapped to multiple discontinuous PRBs of the same subframe, and the PRBs correspond to the same frequency-domain location within two timeslots of the same subframe; the discontinuous PRB resources are distributed and limited into n clusters, and n is an integer larger than or equal to 1; and the RBs included in each cluster are continuous, each cluster includes one or multiple RBs, or, each cluster includes one or multiple continuous RBGs, as shown in FIG. 2, wherein each cluster preferably includes one or multiple continuous RBGs.

When the abovementioned preferred mapping method for discontinuous PRBs is adopted, the first and last RBGs of the two distributed clusters may be indicated to indicate the distributed discontinuous PRB resources here.

At this time, one RBG includes P RBs, wherein a value of P is taken according to a function of a downlink system bandwidth N_{RB}^{DL}, as shown in Table 2.

### Embodiment 7

A network side device transmits data by an NCT, the transmitted data corresponds to a single TB, and the network side device determines a transmission parameter of a PDSCH according to channel state indication information reported by UE in combination with a TM of the UE, version and support capability information of the UE, type information of a serving cell where the PDSCH is located and type information of a subframe where the PDSCH is located; if the version of the UE is UE supporting the NCT, the type of the serving cell where the UE is located is the NCT, the TM configured for the UE is TM10 or TM9 and no CRS or only an RCRS is transmitted in the subframe where the PDSCH is located, then a single-DMRS antenna port-based transmission manner is adopted, mapping is performed according to resources corresponding to multiple DMRS ports, for example, if DMRS ports are (7, 8, 9, 10), only one DMRS port location therein is adopted for DMRS sequence mapping, REs of the other DMRS port locations are idle and PDSCH REs except the REs of the DMRS port locations are adopted for mapping, a power ratio of a reference signal corresponding to the PDSCH to data corresponding to the reference signal is indicated through a localized/distributed VRB indication bit in physical-layer control signalling DCI Format 1A, and/or through an available MCS indication bit and/or through a high-layer signalling information bit, the power ratio of the reference signal corresponding to the PDSCH to the data corresponding to the reference signal is one of 1, 2 and ½, the PDSCH is mapped to multiple discontinuous PRBs of the same subframe, and the PRBs correspond to the same frequency-domain location within two timeslots of the same subframe; the discontinuous PRB resources are distributed and limited into n clusters, and n is an integer larger than or equal to 1; and the RBs included in each cluster are continuous, each cluster includes one or multiple RBs, or, each cluster includes one or multiple continuous RBGs, as shown in FIG. 2, wherein each cluster preferably includes one or multiple continuous RBGs.

When the abovementioned preferred mapping method for discontinuous PRBs is adopted, the first and last RBGs of the two distributed clusters may be indicated to indicate the distributed discontinuous PRB resources here.

At this time, one RBG includes P RBs, wherein a value of P is taken according to a function of a downlink system bandwidth N_{RB}^{DL}, as shown in Table 2.

### Embodiment 8

A network side device transmits data by an NCT, the transmitted data corresponds to a single TB, and the network side device determines a transmission parameter of a PDSCH according to channel state indication information reported by UE in combination with a TM of the UE, version and support capability information of the UE, type information of a serving cell where the PDSCH is located and type information of a subframe where the PDSCH is located; if the version of the UE is UE supporting the NCT, the type of the serving cell where the UE is located is the NCT, the TM configured for the UE is TM10 or TM9 and no CRS or only an RCRS is transmitted in the subframe where the PDSCH is located, then a single-DMRS antenna port-based transmission manner is adopted, a power ratio of a reference signal corresponding to the PDSCH to data corresponding to the reference signal is indicated through a localized/distributed VRB indication bit in physical-layer control signalling DCI Format 1A, and/or through an available MCS indication bit and/or through a high-layer signalling information bit, and the following two states are distinguished through a bit indication:

state 1: mapping is performed according to resources corresponding to multiple DMRS ports, for example, if DMRS ports are (7, 8, 9, 10), only one DMRS port location therein is adopted for DMRS sequence mapping, REs of the other DMRS port locations are idle and PDSCH REs except the REs of the DMRS port locations are adopted for mapping;

state 2: mapping is performed according to resources corresponding to multiple DMRS ports, for example, if the DMRS ports are (7, 8, 9, 10), only one DMRS port location therein is adopted for DMRS sequence mapping and the REs of the other DMRS port locations and the other PDSCH REs are adopted for data mapping;

the power ratio of the reference signal corresponding to the PDSCH to the data corresponding to the reference signal is one of 1, 2 and ½, the PDSCH is mapped to multiple discontinuous PRBs of the same subframe, and the PRBs correspond to the same frequency-domain location within two timeslots of the same subframe; the discontinuous PRB resources are distributed and limited into n clusters, and n is an integer larger than or equal to 1; and the RBs included in each cluster are continuous, each cluster includes one or multiple RBs, or, each cluster includes one or multiple continuous RBGs, as shown in FIG. 2, wherein each cluster preferably includes one or multiple continuous RBGs.

When the abovementioned preferred mapping method for discontinuous PRBs is adopted, the first and last RBGs of the two distributed clusters may be indicated to indicate the distributed discontinuous PRB resources here.

At this time, one RBG includes P RBs, wherein a value of P is taken according to a function of a downlink system bandwidth N_{RB}^{DL}, as shown in Table 2.

### Embodiment 9

A network side device transmits data by an NCT, the transmitted data corresponds to a single TB, and the network side device determines a transmission parameter of a PDSCH according to channel state indication information reported by UE in combination with a TM of the UE, version and support capability information of the UE, type information of a serving cell where the PDSCH is located and type information of a subframe where the PDSCH is located; and if the version of the UE is UE supporting the NCT, the type of the serving cell where the UE is located is the NCT, the TM configured for the UE is TM10 or TM9 and no CRS or only an RCRS is transmitted in the subframe where the PDSCH is located, then a reliable DMRS-port-based transmission manner is adopted, a specific transmission manner may be indicated through a localized/distributed VRB indication bit in physical-layer control signalling DCI Format 1A, and/or through an available MCS indication bit and/or through a high-layer signalling information bit, and a selected transmission manner state combination includes at least one of those listed in Table 3.

For the multi-DMRS antenna port-based transmission manner in state 2 in Table 3,

a DMRS sequence is generated as follows:

$$r ( m ) = \frac{1}{\sqrt{2}} ( 1 - 2 \cdot c ( 2 m ) + j \frac{1}{\sqrt{2}} ( 1 - 2 \cdot c ( 2 m + 1 ) , \\ m = \{ \begin{matrix}0 , 1 , … , 12 {N}_{RB}^{max , DL} - 1 & normal cyclic prefix \\ 0 , 1 , … , 16 {N}_{RB}^{max , DL} - 1 & extended cyclic prefix\end{matrix}$$

where an initial sequence of c(i) is defined as: cᵢₙᵢₜ=(└nₛ/2┘+1)·(2n_{ID}⁽ⁿ^{_{SCID}}⁾+1)·2¹⁶+n_{SCID}, and n_{SCID} represents a scrambling ID;

related parameters may be selected in at least one of manners as follows:

manner 1: two fixed DMRS ports are selected, for example, port 7 and port 9 are fixedly selected, or port 8 and port 10 are fixedly selected, or port 7 and port 8 are fixedly selected; when two fixed DMRS ports are selected, it is also needed to consider the CP type of a subframe;

manner 2: one group of ports (each DMRS port group includes two DMRS ports) is selected from multiple DMRS port groups according to signalling, the DMRS port groups are obtained from a DMRS port set (7, 8, 9, 10), or are obtained from the port set (107, 108, 109, 110), and the required indication signalling is a physical-layer signalling indication or a high-layer signalling indication;

manner 3: n_{SCID} adopts a fixed value during sequence generation of two DMRS ports, and a value range is {0, 1}; the scrambling IDs may adopt the same value, or may adopt different values during sequence generation of the two DMRS ports;

manner 4: n_{SCID} is obtained by signalling configuration during sequence generation of the two DMRS ports, and the value range of the scrambling IDs is {0, 1};

the required scrambling IDs are obtained through the physical-layer signalling or high-layer signalling indication;

manner 5: n_{ID}⁽ⁿ^{_{SCID}}⁾ adopts the same PCI during sequence generation of the two DMRS ports;

manner 6: n_{ID}⁽ⁿ^{_{SCID}}⁾ adopts two fixed virtual IDs during sequence generation of the two DMRS ports, the virtual IDs are integers, a value range is (0, 503], and the two virtual IDs may adopt the same value or adopt different values;

manner 7: n_{ID}⁽ⁿ^{_{SCID}}⁾ is obtained by signalling configuration of two virtual IDs during sequence generation of the two DMRS ports, the virtual IDs are integers, a value range is (0, 503]; the required virtual IDs are obtained through the physical-layer signalling or high-layer signalling indication; and

the power ratio of the reference signal corresponding to the PDSCH to the data corresponding to the reference signal is one of 1, 2 and ½, and the PDSCH is mapped to one or multiple continuous PRBs of the same subframe.

### Embodiment 10

A network side device transmits data by an NCT, the transmitted data corresponds to a single TB, and the network side device determines a transmission parameter of a PDSCH according to channel state indication information reported by UE in combination with a TM of the UE, version and support capability information of the UE, type information of a serving cell where the PDSCH is located and type information of a subframe where the PDSCH is located; and if the version of the UE is UE supporting the NCT, a type of the serving cell where the UE is located is the NCT, the TM configured for the UE is TM10 or TM9 and no CRS or only an RCRS is transmitted in the subframe where the PDSCH is located, then a reliable DMRS-port-based transmission manner is adopted, a specific transmission manner may be indicated through a localized/distributed VRB indication bit in physical-layer control signalling DCI Format 1A, and/or through an available MCS indication bit and/or through a high-layer signalling information bit, and a selected transmission manner state combination includes at least one of those listed in Table 3.

For the multi-DMRS antenna port-based transmission manner in state 2 in Table 3,

a DMRS sequence is generated as follows:

$$r ( m ) = \frac{1}{\sqrt{2}} ( 1 - 2 \cdot c ( 2 m ) + j \frac{1}{\sqrt{2}} ( 1 - 2 \cdot c ( 2 m + 1 ) , \\ m = \{ \begin{matrix}0 , 1 , … , 12 {N}_{RB}^{max , DL} - 1 & normal cyclic prefix \\ 0 , 1 , … , 16 {N}_{RB}^{max , DL} - 1 & extended cyclic prefix\end{matrix}$$

where an initial sequence of c(i) is defined as:

cᵢₙᵢₜ=(└nₛ/2┘+1)·(2n_{ID}⁽ⁿ^{_{SCID}}⁾+1)·2¹⁶+n_{SCID}, and n_{SCID} represents a scrambling ID;

related parameters may be selected in at least one of manners as follows:

manner 1: two fixed DMRS ports are selected, for example, port 7 and port 9 are fixedly selected, or port 8 and port 10 are fixedly selected, or port 7 and port 8 are fixedly selected; when the two fixed DMRS ports are selected, it is also needed to consider the CP type of a subframe;

manner 2: one group of ports (each DMRS port group includes two DMRS ports) is selected from multiple DMRS port groups according to signalling, the DMRS port groups are obtained from a DMRS port set (7, 8, 9, 10), or are obtained from a port set (107, 108, 109, 110), and the required indication signalling is a physical-layer signalling indication or a high-layer signalling indication;

manner 3: n_{SCID} adopts a fixed value during sequence generation of two DMRS ports, and a value range is {0, 1}; the scrambling IDs during sequence generation of two DMRS ports may adopt the same value, or may adopt different values;

manner 4: n_{SCID} is obtained by signalling configuration during sequence generation of the two DMRS ports, and the value range of the scrambling IDs is {0, 1}; the required scrambling IDs are obtained through a physical-layer signalling indication or a high-layer signalling indication;

manner 5: n_{ID}⁽ⁿ^{_{SCID}}⁾ during sequence generation of two DMRS ports adopts the same PCI;

manner 6: n_{ID}⁽ⁿ^{_{SCID}}⁾ during sequence generation of two DMRS ports adopts two fixed virtual IDs, the virtual IDs are integers, a value range is (0, 503], and the two virtual IDs may adopt the same value or adopt different values;

manner 7: n_{ID}⁽ⁿ^{_{SCID}}⁾ during sequence generation of two DMRS ports is obtained by signalling configuration of two virtual IDs, the virtual IDs are integers, a value range is (0, 503]; the required virtual IDs are obtained through the physical-layer signalling indication or high-layer signalling indication; and

the power ratio of the reference signal corresponding to the PDSCH to the data corresponding to the reference signal is one of 1, 2 and ½.

The PDSCH is mapped to multiple discontinuous PRBs of the same subframe, and the PRBs correspond to the same frequency-domain location within two timeslots of the same subframe; the discontinuous PRB resources are distributed and limited into n clusters, and n is an integer larger than or equal to 1; and the RBs included in each cluster are continuous, each cluster includes one or multiple RBs, or, each cluster includes one or multiple continuous RBGs, as shown in FIG. 2, wherein each cluster preferably includes one or multiple continuous RBGs.

When the abovementioned preferred mapping method for discontinuous PRBs is adopted, the first and last RBGs of the two distributed clusters may be indicated to indicate the distributed discontinuous PRB resources here.

At this time, one RBG includes P RBs, wherein a value of P is taken according to a function of a downlink system bandwidth N_{RB}^{DL}, as shown in Table 2.

### Embodiment 11

A network side device transmits data by an NCT, the transmitted data corresponds to a single TB, and the network side device determines a transmission parameter of a PDSCH according to channel state indication information reported by UE in combination with a TM of the UE, version and support capability information of the UE, type information of a serving cell where the PDSCH is located and type information of a subframe where the PDSCH is located; if the version of the UE is UE supporting the NCT, the type of the serving cell where the UE is located is the NCT, the TM configured for the UE is TM10 or TM9, no CRS or only an RCRS is transmitted in the subframe where the PDSCH is located and the like, the transmission parameter of the PDSCH is predefined, and the predefined parameter includes at least one of:

Parameter 1: a resource mapping manner for the PDSCH:

it is predefined that the PDSCH is mapped to one or multiple continuous PRBs of the same subframe;

or, it is predefined that the PDSCH is mapped to multiple discontinuous PRBs and the PRBs correspond to the same frequency-domain location within two timeslots of the same subframe;

or, it is predefined that the PDSCH is mapped to discontinuous PRB resources, the discontinuous PRB resources are distributed and limited into n clusters and n is an integer larger than or equal to 1; and the RBs included in each cluster are continuous, each cluster includes one or multiple RBs, or, each cluster includes one or multiple continuous RBGs, as shown in FIG. 2, wherein each cluster preferably includes one or multiple continuous RBGs.

When the abovementioned preferred mapping method for discontinuous PRBs is adopted, the first and last RBGs of the two distributed clusters may be indicated to indicate the distributed discontinuous PRB resources here.

In the disclosure, one RBG includes P RBs, wherein a value of P is taken according to a function of a downlink system bandwidth N_{RB}^{DL}, as shown in Table 2.

Parameter 2: a sending manner for the PDSCH:

it is predefined that a single-DMRS antenna port is adopted for PDSCH transmission;

or, DMRS-port-based Alamouti transmission diversity is adopted;

or, different-DMRS-ports-based antenna diversity between REs in a PRB is adopted;

or, DMRS-port-based RBF is adopted;

or, a multi-antenna TM using a DMRS as a basic DMRS in a more advanced version is adopted;

Parameter 3: a power ratio of pilot to data during transmission of the PDSCH:

it is predefined that 2 or more DMRS port locations are generated, but only one DMRS port location therein is adopted for DMRS sequence mapping, REs of the other DMRS port locations are adopted to transmit data, power raising is not performed on RE locations which are for transmitting DMRS sequences, and then the power ratio of a reference signal to data corresponding to the reference signal is 1;

or, it is predefined that 2 or more DMRS port locations are generated, but only one DMRS port location therein is adopted for DMRS sequence mapping, REs of the other DMRS port locations are adopted to transmit data, power raising is performed on RE locations which are for transmitting DMRS sequences, and then the power ratio of a reference signal to data corresponding to the reference signal is 2;

or, it is predefined that 2 or more DMRS port locations are generated, but only one DMRS port location therein is adopted for DMRS sequence mapping, REs of the other DMRS port locations are adopted to transmit the data, power reduction is performed on RE locations which are for transmitting DMRS sequences, and then the power ratio of the reference signal to the data corresponding to the reference signal is ½;

or, it is predefined that 2 or more DMRS port locations are generated, but only one DMRS port location therein is adopted for DMRS sequence mapping, REs of the other DMRS port locations are idle, as shown in FIG. 3, power raising is not performed on RE locations which are for transmitting DMRS sequences, and then the power ratio of the reference signal to the data corresponding to the reference signal is 1;

or, it is predefined that 2 or more DMRS port locations are generated, but only one DMRS port location therein is adopted for DMRS sequence mapping, REs of the other DMRS port locations are idle, power raising is performed on RE locations which are for transmitting DMRS sequences, and then the power ratio of the reference signal to the data corresponding to the reference signal is 2; and

or, it is predefined that 2 or more DMRS port locations are generated, but only one DMRS port location therein is adopted for DMRS sequence mapping, REs of the other DMRS port locations are idle, power reduction is performed on RE locations which are for transmitting DMRS sequences, and then the power ratio of the reference signal to the data corresponding to the reference signal is ½.

### Embodiment 12

A network side device transmits data by an NCT, the transmitted data corresponds to a single TB, a TM configured for UE by the network side device is TM10, then a DCI format corresponding to TM10 is DCI Format 1A, and the network side device indicates whether single-DMRS port-based transmission or DMRS-based transmission diversity is adopted through a localized/distributed VRB indication bit in DCI Format 1A; a PDSCH scheduled by DCI Format 1A is mapped to multiple discontinuous PRBs, the PRBs correspond to the same frequency-domain location within two timeslots of the same subframe, the discontinuous PRB resources are distributed and limited into n clusters, and n is an integer larger than or equal to 1; the RBs included in each cluster are continuous, each cluster includes one or multiple RBs, or, each cluster includes one or multiple continuous RBGs, as shown in FIG. 2; and

the UE determines a transmission manner of the PDSCH according to the detected localized/distributed VRB indication bit in DCI Format 1A, and then performs data demodulation.

### Embodiment 13

A network side device transmits data by an NCT, the transmitted data corresponds to a single TB, a TM configured for UE by the network side device is a newly defined TM, DCI formats corresponding to the new TM include DCI Format 1A and DCI Format 1, and the new TM includes a DMRS-based single port TM and/or a diversity TM; the diversity TM includes multi-port-based RBF and multi-port-based SFBC, if multi-DMRS port-based SFBC is adopted for a corresponding PDSCH scheduled by DCI Format 1 by the network side device, the corresponding PDSCH is mapped to multiple discontinuous PRBs, the PRBs correspond to the same frequency-domain location within two timeslots of the same subframe, the discontinuous PRB resources are distributed and limited into n clusters, and n is an integer larger than or equal to 1; the RBs included in each cluster are continuous, each cluster includes one or multiple RBs, or, each cluster includes one or multiple continuous RBGs, as shown in FIG. 2; and

the UE determines a transmission manner of the PDSCH according to detected DCI Format 1, and then performs data demodulation.

### Embodiment 14

A network side device transmits data by an NCT, the transmitted data corresponds to a single TB, a TM configured for UE by the network side device is TM10, then a DCI format corresponding to TM10 is DCI Format 1A, the network side device makes a predefinition that a PDSCH scheduled by DCI Format 1A is transmitted by a single DMRS port, and maps data of the PDSCH with reference to overhead of 2 or more DMRS ports, of which only one DMRS port location is adopted for DMRS sequence mapping and REs of the other DMRS port locations are idle, as shown in FIG. 3, and the network side device indicates a power ratio of a reference signal corresponding to the PDSCH to data corresponding to the reference signal through a localized/distributed VRB indication bit in DCI Format 1A, the ratio being one of 1, 2 and ½; the PDSCH scheduled by DCI Format 1A is mapped to multiple discontinuous PRBs, the PRBs correspond to the same frequency-domain location within two timeslots of the same subframe, the discontinuous PRB resources are distributed and limited into n clusters, and n is an integer larger than or equal to 1; the RBs included in each cluster are continuous, each cluster includes one or multiple RBs, or, each cluster includes one or multiple continuous RBGs, as shown in FIG. 2; and

the UE determines a value of RS_EPRE/PDSCH_EPRE in the PDSCH according to the detected localized/distributed VRB indication bit in DCI Format 1A, and further performs data demodulation according to the predefined single DMRS port.

### Embodiment 15

A network side device transmits data by an NCT, the transmitted data corresponds to a single TB, a TM configured for UE by the network side device is TM10, furthermore, a DCI format corresponding to TM10 is DCI Format 1A, and the network side device makes a predefinition that a PDSCH scheduled by DCI Format 1A is transmitted by a single DMRS port, and makes a predefinition that a PDSCH scheduled by DCI Format 1A is mapped to multiple discontinuous PRBs, the PRBs correspond to the same frequency-domain location within two timeslots of the same subframe, the discontinuous PRB resources are distributed and limited into n clusters, and n is an integer larger than or equal to 1; the RBs included in each cluster are continuous, each cluster includes one or multiple RBs, or, each cluster includes one or multiple continuous RBGs, as shown in FIG. 2; and

the UE determines a transmission manner and resource mapping manner for the PDSCH according to detected DCI Format 1A, and further performs data demodulation.

### Embodiment 16

A network side device transmits data by an NCT, the transmitted data corresponds to a single TB, a TM configured for UE by the network side device is TM10, then a DCI format corresponding to TM10 is DCI Format 1A, a scheduled and transmitted PDSCH is transmitted in subframes 0 and 5, and the network side device performs data transmission by a single CRS port, and performs mapping according to a resource distribution manner indicated in DCI Format 1A; and

the UE detects DCI Format 1A, and then performs data demodulation by the single CRS port and the resource mapping manner indicated in DCI Format 1A.

### Embodiment 17

A network side device transmits data by an NCT, the transmitted data corresponds to a single TB, a TM configured for UE by the network side device is TM10, then a DCI format corresponding to TM10 is DCI Format 1A, the network side device makes a predefinition that a PDSCH scheduled by DCI Format 1A is transmitted by a single DMRS port, maps data of the PDSCH with reference to overhead of 2 or more DMRS ports, and indicates a power ratio of a reference signal corresponding to the PDSCH to data corresponding to the reference signal through a localized/distributed VRB indication bit in DCI Format 1A, the ratio being one of 1, 2 and ½; the PDSCH scheduled by DCI Format 1A is mapped to multiple discontinuous PRBs, the PRBs correspond to the same frequency-domain location within two timeslots of the same subframe, the discontinuous PRB resources are distributed and limited into n clusters, and n is an integer larger than or equal to 1; the RBs included in each cluster are continuous, each cluster includes one or multiple RBs, or, each cluster includes one or multiple continuous RBGs, as shown in FIG. 2; and

the UE determines a value of RS_EPRE/PDSCH_EPRE in the PDSCH according to the detected localized/distributed VRB indication bit in DCI Format 1A, and further performs data demodulation according to the predefined single DMRS port.

Corresponding to the method for PDSCH transmission of the embodiment of the disclosure, an embodiment of the disclosure further provides a network side device, which, as shown in FIG. 4, includes:

a parameter determination module 10, configured to determine a transmission parameter of a PDSCH according to information related to scheduled UE, the transmission parameter of the PDSCH including at least one of the following parameters: a transmission manner of the PDSCH and a power ratio of a reference signal corresponding to the PDSCH to data corresponding to the reference signal, and the information related to the scheduled UE including at least one of: CSI reported by the UE, a TM of the UE, version and support capability information of the UE, type information of a serving cell where the PDSCH is located and type information of a subframe where the PDSCH is located; and

a resource mapping and sending module 20, configured to perform resource mapping and sending according to the determined transmission parameter of the PDSCH.

Preferably, the network side device further includes: a parameter sending module 30, configured to notify the UE of the transmission parameter of the PDSCH.

Preferably, the parameter sending module 30 is configured to notify the UE of the transmission parameter of the PDSCH through physical-layer downlink control signalling information and/or high-layer signalling information.

Preferably, the parameter determination module 10 is configured to predefine the transmission parameter of the PDSCH according to the information related to the scheduled UE.

Preferably, a resource mapping and sending manner for the PDSCH includes at least one of manners as follows:

the PDSCH is mapped to one or multiple continuous PRBs of the same subframe, and the PDSCH adopts a single-DMRS antenna port-based TM;

or, the PDSCH is mapped to one or multiple continuous PRBs of the same subframe, and the PDSCH adopts a multi-DMRS antenna port-based TM;

or, the PDSCH is mapped to multiple continuous PRBs, the PRBs correspond to the same frequency-domain location within two timeslots of the same subframe, and the PDSCH adopts the single-DMRS antenna port-based TM;

or, the PDSCH is mapped to multiple discontinuous PRBs, the PRBs correspond to the same frequency-domain location within two timeslots of the same subframe, and the PDSCH adopts the multi-DMRS antenna port-based TM.

Preferably, the operation that the PDSCH is mapped to the multiple discontinuous PRBs may include that:

discontinuous PRB resources are distributed into n clusters, n is an integer larger than or equal to 1, each cluster includes the same number of RBs, and the RBs included in each cluster are continuous; cluster intervals are selected to be equal intervals, or are randomly selected, or are selected according to fed back sub-band CSI;

or, the discontinuous PRB resources are distributed into n clusters, n is an integer larger than or equal to 1, each cluster includes different numbers of RBs, and the RBs included in each cluster are continuous; the cluster intervals are selected to be equal intervals, or are randomly selected, or are selected according to the fed back sub-band CSI;

or, the discontinuous PRB resources are distributed into n clusters, n is an integer larger than or equal to 1, each cluster includes the same number of RBs, and the RBs included in each cluster are discontinuous; the cluster intervals are selected to be equal intervals, or are randomly selected, or are selected according to the fed back sub-band CSI;

or, the discontinuous PRB resources are distributed into n clusters, n is an integer larger than or equal to 1, each cluster includes different numbers of RBs, and the RBs included in each cluster are discontinuous; the cluster intervals are selected to be equal intervals, or are randomly selected, or are selected according to the fed back sub-band CSI;

or, n PRBs are distributed at equal intervals during distribution of the discontinuous PRB resources;

or, n discontinuous PRBs which are randomly distributed are distributed during distribution of the discontinuous PRB resources.

Preferably, the multi-DMRS antenna port-based TM includes at least one of manners as follows:

DMRS-port-based Alamouti transmission diversity; antenna diversity based on different DMRS ports between REs in a PRB; DMRS-port-based RBF; and a new multi-antenna TM using a DMRS as a basic DMRS.

Preferably, multi-DMRS antenna port-based selection in the multi-DMRS antenna port-based TM includes at least one of manners as follows:

two fixed DMRS ports are selected; and

each DMRS port group includes two DMRS ports, and one port group is selected from multiple DMRS port groups according to signalling.

Preferably, when the DMRS ports are selected, selection of main IDs and scrambling IDs during sequence initialization of the selected DMRS antenna ports is performed by at least one of manners as follows:

the scrambling IDs during sequence generation of the two DMRS ports adopt fixed values;

the scrambling IDs during sequence generation of the two DMRS ports are obtained by signalling configuration;

the IDs during sequence generation of the two DMRS ports adopt the same PCI;

the IDs during sequence generation of the two DMRS ports adopt two fixed virtual IDs; and

the IDs during sequence generation of the two DMRS ports are obtained by signalling configuration of two virtual IDs.

Preferably, resource mapping of the PDSCH in the single-DMRS antenna port-based TM includes: mapping according to resources corresponding to a single antenna port, or, mapping according to resources corresponding to multiple antenna ports.

Preferably, the power ratio of the data corresponding to the reference signal is a pilot-power-to-data-power ratio RS_EPRE/PDSCH_EPRE during transmission of the PDSCH, and a value of RS_EPRE/PDSCH_EPRE may be one of 1, 2 and ½, or may be one of 0 dB, 3 dB and −3 dB.

Preferably, the high-layer signalling information includes at least one of: system information obtained during initial access of the UE; and RRC configuration information obtained when the UE is in an RRC connection state.

Preferably, the resource mapping and sending module 20 is configured to indicate the transmission manner of the PDSCH and/or the power ratio of the data corresponding to the reference signal in at least one of manners as follows:

a localized/distributed VRB indication bit in DCI Format 1A,

an available MCS indication bit,

a new bit in DCI Format 1A,

a DCI format corresponding to a newly defined TM,

a high-layer signalling information bit, and

a predefined manner.

Preferably, the TM of the UE is TM10, or the newly defined TM;

the newly defined TM has characteristics as follows:

DCI formats corresponding to the TM include DCI Format 1A and DCI Format 1, or may include DCI Format 1A and DCI Format 1 E;

the TM is a single-DMRS port-based TM and/or a diversity TM; and the diversity TM includes multi-port-based RBF and multi-port SFBC.

It is to be noted that the parameter determination module 10, the resource mapping and sending module 20 and the parameter sending module 30 may be implemented by a Central Processing Unit (CPU), a Micro Processing Unit (MPU), a Digital Signal Processor (DSP) or a Field-Programmable Gate Array (FPGA) of the network side device.

UE, as shown in FIG. 5, includes:

a transmission parameter acquisition module 40, configured to acquire a transmission parameter, which is notified by a network side device, of a PDSCH, or, determine a transmission parameter of a PDSCH according to information related to the UE; and

a data receiving module 50, configured to receive data according to the transmission parameter, which is notified by the network side device, of the PDSCH, and/or receive data according to the transmission parameter, which is determined by the transmission parameter acquisition module 40, of the PDSCH, wherein

the transmission parameter of the PDSCH includes at least one of the following parameters: a transmission manner of the PDSCH and a power ratio of a reference signal corresponding to the PDSCH to data corresponding to the reference signal; and

the information related to the UE includes at least one of: CSI reported by the UE, a TM of the UE, version and support capability information of the UE, type information of a serving cell where the PDSCH is located and type information of a subframe where the PDSCH is located.

Preferably, the transmission parameter acquisition module 40 is configured to obtain the transmission parameter, which is notified by the network side device, of the PDSCH through physical-layer downlink control signalling information and/or high-layer signalling information.

Preferably, the high-layer signalling information includes at least one of: system information obtained during initial access of the UE; and RRC configuration information obtained when the UE is in an RRC connection state.

Preferably, the transmission parameter acquisition module 40 is configured to acquire the corresponding transmission parameter of the PDSCH through a bit in an MIB in the high-layer signalling information; or, acquire the corresponding transmission parameter of the PDSCH through UE-level RRC configuration information in the high-layer signalling information.

Preferably, the operation that the transmission parameter acquisition module 40 obtains the transmission parameter of the PDSCH through the physical-layer downlink control signalling information includes that:

the transmission manner of the PDSCH and/or the power ratio of the data corresponding to the reference signal are/is obtained in at least one of manners as follows:

a localized/distributed VRB indication bit in DCI Format 1A,

an available MCS indication bit,

a new bit in DCI Format 1A,

a DCI format corresponding to a newly defined TM,

a high-layer signalling information bit, and

a predefined manner.

It is to be noted that the transmission parameter acquisition module 40 and the data receiving module 50 may be implemented by a CPU, MPU, DSP or FPGA of the UE.

An embodiment of the disclosure further provides a system for PDSCH transmission including the network side device in the abovementioned embodiment and the UE in the abovementioned embodiment, and in the system, functions of the network side device and the UE may refer to the description in the abovementioned embodiments, and will not be elaborated herein.

An embodiment of the disclosure further provides a computer-readable storage medium, which includes a set of computer-executable instructions, the instructions being configured to execute a method for PDSCH transmission for a network side device in the abovementioned embodiment.

An embodiment of the disclosure further provides a computer-readable storage medium, which includes a set of computer-executable instructions, the instructions being configured to execute a method for PDSCH transmission for a UE side in the abovementioned embodiment.

The above are only the preferred embodiments of the disclosure and not intended to limit the scope of protection of the disclosure.

What is claimed is:

1. A method for Physical Downlink Shared Channel (PDSCH) transmission comprising:
determining, by a network side device, a transmission parameter of a PDSCH according to information related to scheduled User Equipment (UE), the transmission parameter of the PDSCH comprising at least one of following parameters: a transmission manner of the PDSCH, and a power ratio of a reference signal corresponding to the PDSCH to data corresponding to the reference signal; and the information related to the scheduled UE comprising at least one of: Channel State Information (CSI) reported by the UE, a Transmission Mode (TM) of the UE, version and support capability information of the UE, type information of a serving cell where the PDSCH is located, and type information of a subframe where the PDSCH is located; and
performing, by the network side device, resource mapping and sending according to the determined transmission parameter of the PDSCH.

2. The method for PDSCH transmission according to claim 1, further comprising:
notifying, by the network side device, the UE of the transmission parameter of the PDSCH; wherein
notifying, by the network side device, the transmission parameter of the PDSCH to the UE comprises: notifying the UE of the transmission parameter of the PDSCH through physical-layer downlink control signalling information and/or high-layer signalling information; or,
the method further comprises: predefining, by the network side device, the transmission parameter of the PDSCH according to the information related to the scheduled UE.

3-4. (canceled)

5. The method for PDSCH transmission according to claim 1, wherein the resource mapping and sending is performed for the PDSCH in at least one of manners as follows:
the PDSCH is mapped to one or multiple continuous Physical Resource Blocks (PRBs) of a same subframe, and the PDSCH adopts a single-Demodulation Reference Signal (DMRS) antenna port-based TM;
or, the PDSCH is mapped to one or multiple continuous PRBs of a same subframe, and the PDSCH adopts a multi-DMRS antenna port-based TM;
or, the PDSCH is mapped to multiple continuous PRBs, the PRBs correspond to a same frequency-domain location within two timeslots of a same subframe, and the PDSCH adopts a single-DMRS antenna port-based TM;
or, the PDSCH is mapped to multiple discontinuous PRBs, PRBs correspond to a same frequency-domain location within two timeslots of a same subframe, and the PDSCH adopts a multi-DMRS antenna port-based TM.

6. The method for PDSCH transmission according to claim 5, wherein mapping the PDSCH to the multiple discontinuous PRBs comprises: distributing the discontinuous PRBs into n clusters, wherein n is an integer larger than or equal to 1, and RBs comprised in each cluster are continuous;
or,
wherein the multi-DMRS antenna port-based TM comprises at least one of manners as follows:
DMRS-port-based Alamouti transmission diversity;
antenna diversity based on different DMRS ports between Resource Elements (REs) in a PRB;
DMRS-port-based Random Beam Forming (RBF); and
a new multi-antenna TM using a DMRS as a basic DMRS;
or,
wherein multi-DMRS antenna port-based selection in the multi-DMRS antenna port-based TM comprises at least one of manners as follows:
two fixed DMRS ports are selected; and
each DMRS port group comprises two DMRS ports, and one port group is selected from multiple DMRS port groups according to signalling.

7-8. (canceled)

9. The method for PDSCH transmission according to claim 8, wherein, when the DMRS ports are selected, main Identities (IDs) and scrambling IDs during sequence initialization of the selected DMRS antenna ports are selected in at least one of manners as follows:
the scrambling IDs during sequence generation of the two DMRS ports adopt fixed values;
the scrambling IDs during sequence generation of the two DMRS ports are obtained by signalling configuration;
the main IDs during sequence generation of the two DMRS ports adopt a same Physical Cell ID (PCI);
the main IDs during sequence generation of the two DMRS ports adopt two fixed virtual IDs; and
the main IDs during sequence generation of the two DMRS ports are obtained by signalling configuration of two virtual IDs.

10. (canceled)

11. The method for PDSCH transmission according to claim 1, wherein the power ratio of the data corresponding to the reference signal is a pilot-power-to-data-power ratio RS_EPRE/PDSCH_EPRE during transmission of the PDSCH, and the RS_EPRE/PDSCH_EPRE has a value which is one of 1, 2 and ½, or is one of 0 dB, 3 dB and −3 dB.

12. The method for PDSCH transmission according to claim 3, wherein the high-layer signalling information comprises at least one of following information:
system information obtained during initial access of the UE; and
Radio Resource Control (RRC) configuration information obtained when the UE is in an RRC connection state.

13. (canceled)

14. The method for PDSCH transmission according to claim 1, comprising: indicating the transmission manner of the PDSCH and/or the power ratio of the data corresponding to the reference signal in at least one of manners as follows:
a localized/distributed Virtual Resource Block (VRB) indication bit in Downlink Control Information (DCI) Format 1A,
an available Modulation and Coding Scheme (MCS) indication bit,
a new bit in DCI Format 1A,
a DCI format corresponding to a newly defined TM,
a high-layer signalling information bit, and
a predefined manner.

15. The method for PDSCH transmission according to claim 1, wherein the TM of the UE is TM10, or a newly defined TM;
the newly defined TM has characteristics as follows:
DCI formats corresponding to the newly defined TM comprises DCI Format 1A and DCI Format 1, or comprises DCI Format 1A and DCI Format 1E;
the newly defined TM is a single-DMRS port-based TM and/or a diversity TM; and the diversity TM comprises multi-port-based Random Beam Forming (RBF) and multi-port Space-Frequency Block Coding (SFBC).

16-20. (canceled)

21. A network side device, comprising:
a parameter determination module, configured to determine a transmission parameter of a Physical Downlink Shared Channel (PDSCH) according to information related to scheduled User Equipment (UE), the transmission parameter of the PDSCH comprising at least one of following parameters: a transmission manner of the PDSCH, a power ratio of a reference signal corresponding to the PDSCH to data corresponding to the reference signal, and the information related to the scheduled UE comprising at least one of: Channel State Information (CSI) reported by the UE, a Transmission Mode (TM) of the UE, version and support capability information of the UE, type information of a serving cell where the PDSCH is located and type information of a subframe where the PDSCH is located; and
a resource mapping and sending module, configured to perform resource mapping and sending according to the determined transmission parameter of the PDSCH.

22. The network side device according to claim 21, further comprising a parameter sending module configured to notify the UE of the transmission parameter of the PDSCH, wherein
the parameter sending module is configured to notify the UE of the transmission parameter of the PDSCH through physical-layer downlink control signalling information and/or high-layer signalling information; or,
the parameter determination module is configured to predefine the transmission parameter of the PDSCH according to the information related to the scheduled UE.

23-24. (canceled)

25. The network side device according to claim 21, wherein the resource mapping and sending is performed for the PDSCH in at least one of manners as follows:
the PDSCH is mapped to one or multiple continuous Physical Resource Blocks (PRBs) of a same subframe, and the PDSCH adopts a single-Demodulation Reference Signal (DMRS) antenna port-based TM;
or, the PDSCH is mapped to one or multiple continuous PRBs of a same subframe, and the PDSCH adopts a multi-DMRS antenna port-based TM;
or, the PDSCH is mapped to multiple continuous PRBs, the PRBs correspond to the same frequency-domain location within two timeslots of a same subframe, and the PDSCH adopts a single-DMRS antenna port-based TM;
or, the PDSCH is mapped to multiple discontinuous PRBs, the PRBs correspond to a same frequency-domain location within two timeslots of a same subframe, and the PDSCH adopts a multi-DMRS antenna port-based TM.

26. The network side device according to claim 25, wherein mapping the PDSCH to the multiple discontinuous PRBs comprises: distributing the discontinuous PRBs into n clusters, n is an integer larger than or equal to 1, and RBs comprised in each cluster are continuous;
or,
the multi-DMRS antenna port-based TM comprises at least one of manners as follows:
DMRS-port-based Alamouti transmission diversity;
antenna diversity based on different DMRS ports between REs in a PRB;
DMRS-port-based Random Beam Forming (RBF); and
a new multi-antenna TM using a DMRS as a basic DMRS;
or,
wherein multi-DMRS antenna port-based selection in the multi-DMRS antenna port-based TM comprises at least one of manners as follows:
two fixed DMRS ports are selected; and
each DMRS port group comprises two DMRS ports, and one port group is selected from multiple DMRS port groups according to signalling.

27-28. (canceled)

29. The network side device according to claim 28, wherein, when the DMRS ports are selected, main Identities (IDs) and scrambling IDs during sequence initialization of the selected DMRS antenna ports comprises are selected in at least one of manners as follows:
the scrambling IDs during sequence generation of the two DMRS ports adopt fixed values;
the scrambling IDs during sequence generation of the two DMRS ports are obtained by signalling configuration;
the main IDs during sequence generation of the two DMRS ports adopt a same Physical Cell ID (PCI);
the main IDs during sequence generation of the two DMRS ports adopt two fixed virtual IDs; and
the main IDs during sequence generation of the two DMRS ports are obtained by signalling configuration of two virtual IDs.

30. (canceled)

31. The network side device according to claim 21, wherein the power ratio of the data corresponding to the reference signal is a pilot-power-to-data-power ratio RS_EPRE/PDSCH_EPRE during transmission of the PDSCH, and the RS_EPRE/PDSCH_EPRE has a value which is one of 1, 2 and ½, or is one of 0 dB, 3 dB and −3 dB.

32. The network side device according to claim 23, wherein the high-layer signalling information comprises at least one of:
system information obtained during initial access of the UE; and
Radio Resource Control (RRC) configuration information obtained when the UE is in an RRC connection state.

33. The network side device according to claim 21, wherein the resource mapping and sending module is configured to indicate the transmission manner of the PDSCH and/or the power ratio of the data corresponding to the reference signal in at least one of manners as follows:
a localized/distributed Virtual Resource Block (VRB) indication bit in Downlink Control Information (DCI) Format 1A,
an available Modulation and Coding Scheme (MCS) indication bit,
a new bit in DCI Format 1A,
a DCI format corresponding to a newly defined TM,
a high-layer signalling information bit, and
a predefined manner.

34. The network side device according to claim 21, wherein the TM of the UE is TM10, or a newly defined TM;
the newly defined TM has characteristics as follows:
DCI formats corresponding to the newly defined TM comprises DCI Format 1A and DCI Format 1, or comprises DCI Format 1A and DCI Format 1E;
the newly defined TM is a single-DMRS port-based TM and/or a diversity TM; and the diversity TM comprises multi-port-based RBF and multi-port Space-Frequency Block Coding (SFBC).

35. User Equipment (UE), comprising:
a transmission parameter acquisition module, configured to acquire a transmission parameter, which is notified by a network side device, of a Physical Downlink Shared Channel (PDSCH), or, determine a transmission parameter of a PDSCH according to information related to the UE; and
a data receiving module, configured to receive data according to the transmission parameter, which is notified by the network side device, of the PDSCH, and/or receive data according to the transmission parameter, which is determined by the transmission parameter acquisition module, of the PDSCH; wherein
the transmission parameter of the PDSCH comprises at least one of following parameters: a transmission manner of the PDSCH, a power ratio of a reference signal corresponding to the PDSCH to data corresponding to the reference signal; and
the information related to the UE comprises at least one of: Channel State Information (CSI) reported by the UE, a Transmission Mode (TM) of the UE, version and support capability information of the UE, type information of a serving cell where the PDSCH is located, and type information of a subframe where the PDSCH is located.

36. The UE according to claim 35, wherein the transmission parameter acquisition module is configured to obtain the transmission parameter, which is notified by the network side device, of the PDSCH through physical-layer downlink control signalling information and/or high-layer signalling information.

37. The UE according to claim 36, wherein the high-layer signalling information comprises at least one of:
system information obtained during initial access of the UE; and
Radio Resource Control (RRC) configuration information obtained when the UE is in an RRC connection state.

38. The UE according to claim 37, wherein the transmission parameter acquisition module is configured to acquire a corresponding transmission parameter of the PDSCH through a bit in a Main Information Block (MIB) in the high-layer signalling information, or, acquire a corresponding transmission parameter of the PDSCH through UE-level RRC configuration information in the high-layer signalling information.

39. The UE according to claim 35, wherein obtaining the transmission parameter of the PDSCH by the transmission parameter acquisition module through the physical-layer downlink control signalling information comprises:
the transmission manner of the PDSCH and/or the power ratio of the data corresponding to the reference signal are/is obtained in at least one of manners as follows:
a localized/distributed Virtual Resource Block (VRB) indication bit in Downlink Control Information (DCI) Format 1A,
an available Modulation and Coding Scheme (MCS) indication bit,
a new bit in DCI Format 1A,
a DCI format corresponding to a newly defined TM,
a high-layer signalling information bit, and
a predefined manner.

40-42. (canceled)
